(19) United States
(12) Patent Application Publication
(10) Pub. No.: US 2026/0016765 A1
(43) Pub. Date: Jan. 15, 2026

(54) MAGNETIC CARRIER FOR ELECTROSTATIC CHARGE IMAGE DEVELOPMENT

(71) Applicant: CANON KABUSHIKI KAISHA, Tokyo (JP)

(72) Inventors: NOBUHIRO YOSHIDA, Ibaraki (JP); MIZUKI SAITO, Chiba (JP); KOHEI YOSHIYAMA, Chiba (JP); YUU NISHIMURA, Chiba (JP); KENTARO KAMAE, Kanagawa (JP); TORU TAKAHASHI, Ibaraki (JP); HITOSHI SANO, Chiba (JP); TAKAHO SHIBATA, Tokyo (JP)

(21) Appl. No.: 19/260,047

(22) Filed: Jul. 3, 2025

(30) Foreign Application Priority Data
Jul. 9, 2024 (JP) 2024-110317

(51) Int. Cl. G03G 9/113; G03G 9/107

(52) U.S. Cl. CPC G03G 9/1138; G03G 9/1085; G03G 9/1133; G03G 9/1136

(57) ABSTRACT

A magnetic carrier for electrostatic charge image development, wherein the magnetic core particle is a particle having a silicone resin on the surface; the coating resin layer is a layer containing a vinyl-based resin as a binder resin, and a silica particle; and when a mass of the magnetic carrier for electrostatic charge image development after having been held for 5 hours in a first environment of a temperature of 30° C. and a relative humidity of 80% is defined as M1, and a mass of the magnetic carrier for electrostatic charge image development which has been held in the first environment, after having been held in a second environment of a temperature of 23° C. and a relative humidity of 5% for 5 hours, is defined as M2, M1 and M2 satisfy Expression (1): 0.055≤(M1−M2)/M1×100≤0.200 Expression (1).

### BACKGROUND

### Field of the Technology

The present disclosure relates to a magnetic carrier for electrostatic charge image development, which is used in an image forming method for visualizing an electrostatically charged image with a use of an electrophotographic system.

### Description of the Related Art

Conventionally, the image forming method of the electrophotographic system, which is generally used, is a method of forming an electrostatic latent image on an electrostatic latent image carrying body with a use of various methods, attaching a toner to the electrostatic latent image, and thereby developing the electrostatic latent image. For this development, a two-component development system is widely adopted that mixes a carrier particle which is called a magnetic carrier, with a toner, triboelectrically charges the toner, imparts an appropriate amount of a positive or negative electric charge to the toner, and allows development while using the electric charge as a driving force.

The two-component development system can impart functions such as stirring, conveying and charging of the developer, to the magnetic carrier, and accordingly, the function which shares with the toner is clear; and because of this, has advantages that controllability of developer performance is satisfactory, etc. Here, in many cases, the magnetic carrier is configured to include a magnetic core for acquiring a conveying property by having magnetism, and a coating resin which is coated on the magnetic core for allowing the magnetic core to acquire a charge imparting ability to the toner.

A density of an image formed by an electrophotographic system varies due to an influence of a charged amount of the toner, and accordingly, an image forming apparatus of the electrophotographic system is generally equipped with a mechanism for keeping a final image density constant by adjusting development conditions. However, it is known that when such a change of the charged amount of the toner as to deviate from an adjustment range has occurred due to a cause such as changes of a temperature and humidity in a space in which an apparatus is installed, adverse effects occur such as a decrease in the image density caused by an excessively charged amount, and contamination in the apparatus due to scattering of the toner which is caused by an insufficiently charged amount. In a configuration of the image which forms apparatus for corresponding to recent needs such as a high image quality and a high speed, an occurrence of these harmful phenomena tends to become remarkable, and such a developer is required as to improve both characteristics.

In a two-component development system, charging characteristics of the toner can be changed by the previously described configuration of the magnetic carrier, and accordingly, the magnetic carrier is known in which a configuration of a coating resin layer is particularly devised.

Japanese Patent Laid-Open No. S58-117555 proposes a carrier for an electrophotographic dry developer, including a core material and a coating layer on a surface of a core material, the coating layer which is formed by curing an epoxy resin containing a fine silica particle by a polyamide resin.

Japanese Patent Laid-Open No. 2022-181065 discloses a carrier for electrostatic charge image development, including a magnetic particle and a resin layer that covers the magnetic particle and that contains a silica particle having an average particle diameter of 50 nm or larger and 200 nm or smaller, wherein, when a ratio of Si element in a region in which a distance in a direction from a surface of the resin layer to the inner part is 0.1 μm or larger and 0.2 μm or smaller is defined as Si1, and a ratio of Si element in a region in which a distance in a direction from the surface of the magnetic particle to the surface of the resin layer is 0 μm or larger and 0.1 μm smaller is defined as Si2, the following is satisfied:

$$0.005 \leq Si 1 \leq 2 , and \qquad Expression 1 - 1$$

$$1 \leq Si 1 / Si 2 \leq 1000. \qquad Expression 2 - 1$$

### SUMMARY

In order to solve the above disadvantages, an aspect of the present disclosure is to provide a magnetic carrier for electrostatic charge image development, which suppresses a decrease in image density caused by an excessive increase in a charged amount of a toner in a low-humidity environment, and suppresses contamination in an image forming apparatus due to toner scattering which is caused by a decrease in the charged amount of the toner in a high-humidity environment.

In order to solve the above disadvantage, the present disclosure provides a magnetic carrier for electrostatic charge image development, having a magnetic core particle and a coating resin layer that covers a surface of the magnetic core particle, wherein the magnetic core particle is a particle having a silicone resin on the surface; the coating resin layer is a layer containing a vinyl-based resin as a binder resin, and containing a silica particle; and when a mass of the magnetic carrier for electrostatic charge image development after having been held for 5 hours in a first environment of a temperature of 30° C. and a relative humidity of 80% is defined as M1, and a mass of the magnetic carrier for electrostatic charge image development which has been held in the first environment for 5 hours, after having been held in a second environment of a temperature of 23° C. and a relative humidity of 5% for 5 hours, is defined as M2, M1 and M2 satisfy the following Expression (1).

$$0.055 \leq ( M 1 - M 2 ) / M 1 \times 100 \leq 0.200 \qquad Expression ( 1 )$$

Features of the present disclosure will become apparent from the following description of embodiments with reference to attached drawings. The following description of embodiments are described by way of example.

### BRIEF DESCRIPTION OF THE DRAWINGS

FIG. 1 is a secondary electron image obtained by observing a surface of the carrier used in the present disclosure.

FIG. 2 is a schematic view of a surface treatment apparatus used in the present disclosure.

### DESCRIPTION OF THE EMBODIMENTS

### One Embodiment

One embodiment relates to a magnetic carrier for electrostatic charge image development.

The magnetic carrier for electrostatic charge image development of the present disclosure is a magnetic carrier for electrostatic charge image development, having a magnetic core particle and a coating resin layer that covers the surface of the magnetic core particle, wherein the magnetic core particle is a particle having a silicone resin on the surface; and the coating resin layer is a layer containing a vinyl-based resin as a binder resin, and containing a silica particle, and when a mass of the magnetic carrier for electrostatic charge image development after having been held for 5 hours in a first environment of a temperature of 30° C. and a relative humidity of 80% is defined as M1, and a mass of the magnetic carrier for electrostatic charge image development which has been held in the first environment for 5 hours, after having been held in a second environment of a temperature of 23° C. and a relative humidity of 5% for 5 hours, is defined as M2, the M1 and the M2 satisfy the following Expression (1).

$$0.055 \leq ( M 1 - M 2 ) / M 1 \times 100 \leq 0.200 \qquad Expression ( 1 )$$

Embodiments of the present disclosure will be described below in more detail.

The magnetic carrier for electrostatic charge image development (hereinafter also referred to as carrier) according to the present disclosure has the above configuration; and thereby can suppress a decrease in image density caused by an excessive increase in a charged amount of a toner in a low-humidity environment, and can suppress contamination in an image forming apparatus, due to toner scattering caused by a decrease in the charged amount of the toner in a high-humidity environment. The action thereof is not clear, but is assumed to be the following.

In a case where images particularly having a low image ratio have been continuously output in a low-humidity environment, the charged amount of the toner excessively increases, an amount of the toner that can fly decreases with respect to a magnitude of development contrast which has been formed on an image carrying body, and an image density when the toner image has been formed decreases, in some cases. The carrier that is used in the present disclosure contains a silica particle in a coating resin layer; and the silica particle generally has a higher negative chargeability than the coating resin of the carrier, and accordingly has a small difference in triboelectric series which is compared to that of the toner surface, and has an action of preventing the charged amount of the toner from becoming excessively large.

Furthermore, the carrier satisfies that a mass reduction rate of Expression (1) is 0.055% or larger, accordingly, a reduction amount of moisture is large in the low-humidity environment when the high-humidity environment and the low-humidity environment have been compared with each other, and negative property of a surface of the carrier in the low-humidity environment is in a higher state; and it is considered that such action is large as to prevent the charged amount of the toner from becoming excessively large. For information, in the present disclosure, the M1 and the M2 can be confirmed with the use of a thermogravimetric analysis device, for example.

In addition, in a case where images particularly having a high image ratio are continuously output in a high-humidity environment, an abundance ratio of the toner becomes high of which the charged amount is small, and an adhesive force between the carrier and the toner decreases; and thereby, the toner scatters from the developing machine, and contaminates an inside of an image forming apparatus, in some cases. It is known that such a phenomenon tends to become more remarkable in the carrier which contains a silica particle which has the high negative property, in the coating resin layer; but it is considered that because the carrier according to the present disclosure satisfies that a mass reduction rate of Expression (1) is 0.055% or larger, an increase amount of moisture in the high-humidity environment is large when the high-humidity environment and the low-humidity environment are compared with each other, and the negative property of the surface of the carrier in the high-humidity environment is in a relatively low state; and it is considered to be because the carrier has a higher ability to impart charge to the toner even in a high-humidity environment than a conventional carrier containing the silica particle.

In addition, in the magnetic carrier for electrostatic charge image development of the present disclosure, the magnetic core particle has a particle having a silicone resin on the surface. In other words, in the carrier according to the present disclosure, the surface of the magnetic core particle is coated with the silicone resin. The silicone resin has a higher affinity to the silica particle than the magnetic body, and existing probability of the silica particle becomes high in a vicinity of the silicone resin which covers the core when the carrier is produced, and probability of contact of the silica particles with magnetic body portion of the magnetic core particle decreases, thereby has an action of suppressing a decrease in the charged amount of the toner due to leakage of an electric charge from the toner through the magnetic body portion, which is a material having a lower resistance than resin component. The carrier that is used in the present disclosure has a large water content in a high-humidity environment as previously described, but has a structure that can improve the charged amount stability in a high-humidity environment, by reducing a frequency of contact between the silica particle and the magnetic body.

In addition, in the magnetic carrier for electrostatic charge image development of the present disclosure, the coating resin layer is a layer which includes a vinyl-based resin as a binder resin, and includes the silica particle. The vinyl-based resin has a higher ability to impart charge to the toner than other resins, and has a function of sufficiently ensuring the charged amount of the toner in a high-humidity environment. In the present disclosure, a type of chemical substance can be confirmed by nuclear magnetic resonance (NMR), for example.

From the above reasons, it is assumed that the carrier according to the present disclosure suppresses a decrease in the image density caused by an excessive increase in the charged amount of the toner in a low-humidity environment, and also can suppress contamination in an image forming apparatus due to toner scattering caused by a decrease in the charged amount of the toner under a high-humidity environment.

In addition, the carrier according to the present disclosure satisfies that the mass reduction rate of Expression (1) is 0.200% or smaller. When the mass reduction rate of the Expression (1) is larger than 0.200%, it is considered that a water content of the carrier is too large in a high-humidity environment, and it has been impossible to sufficiently obtain an effect of suppressing contamination in the image forming apparatus due to toner scattering.

In addition, in the magnetic carrier for electrostatic charge image development of the present disclosure, it is preferable that a proportion of an area of the portion in which the silica particles are exposed with respect to the surface area of the coating resin layer is 10% or larger, on the surface of the magnetic carrier for electrostatic charge image development. By doing this, probability of contact of the silica particles having high negative property with the toner increases, the negative property of the surface of the carrier in a low-humidity environment become higher, and an action of preventing the charged amount of the toner from becoming excessively large becomes large. Then, a decrease in the image density caused by an excessive increase in the charged amount of the toner in a low-humidity environment can be further suppressed. It is more preferable that the exposure proportion of the silica particles is 13% or larger, because the negative property of the surface of the carrier can be further enhanced.

It is preferable that the magnetic carrier for electrostatic charge image development of the present disclosure is formed so that the surface of the magnetic body is covered by 80% or more. When the surface of the magnetic body is sufficiently coated, an effect of improving the charged amount stability in a high-humidity environment can be exhibited more easily. This is considered to be because, when the surface of the magnetic body is sufficiently covered, proportion of exposed portion of the magnetic body decreases which is a material having a lower resistance than the resin component. When 90% or more of the surface of the magnetic body is covered, the above effect is more remarkably exhibited, and accordingly, a more suitable form is obtained.

In the magnetic carrier for electrostatic charge image development of the present disclosure, it is preferable that magnetization of the carrier is 40 (Am²/kg) or larger and 80 (Am²/kg) or smaller in a magnetic field of 1000/4π (kA/m)). When an intensity of magnetization of the carrier is within the above range, the magnetic binding force to the developing sleeve is appropriate, and accordingly, an occurrence of carrier adhesion can be more adequately suppressed. In addition, stress which is applied to the toner in the magnetic brush can be reduced, and accordingly deterioration of the toner and adhesion of the toner to other members can adequately be suppressed.

In the magnetic carrier for electrostatic charge image development according to the present disclosure, it is preferable that a volume-average particle diameter (D50) is 20 μm or larger and 80 μm or smaller, from a viewpoint of charge imparting ability to the toner, the suppression of the adhesion of the carrier to the image region, and the enhancement of the image quality. It is more preferable to be 20 μm or larger and 60 μm or smaller.

### <Magnetic Core Particle>

The magnetic core particle according to the present disclosure is not particularly limited as long as the magnetic core particle satisfies the range defined in the present disclosure, and known magnetic body particles can be used which are used as a core material of the carrier. Specific examples thereof include: a magnetic body particle of which the surface is coated with a silicone resin; and a magnetic body particle having a structure in which a silicone resin is distributed inside and on the surface of the magnetic body particle having a pore. As the magnetic body, a general known material can be used without particular limitation, and for example, materials can be used which include: a magnetic metal such as iron, nickel and cobalt; an oxide of the magnetic metal; and the oxide to which a metal element such as manganese, magnesium, strontium, copper or zinc is added.

As the magnetic core particle in the embodiment of the present disclosure, the particle is preferable in which a silicone resin is distributed inside and on the surface of a metal oxide particle such as ferrite or magnetite having a pore. This is because the silicone resin has low affinity with the magnetic body, accordingly, an adhesive force at an interface with the magnetic body is weak, and the resin layer is peeled off when having been used for a long period of time in some cases, but it is considered that a structure in which the silicone resin is filled even in an inside of the magnetic body particle resists peeling of the resin layer.

As the silicone resin for covering the magnetic body, a compound having a polysiloxane structure is used. For example, the materials can be used which include: a cured product of a silicone resin such as a methyl silicone resin and a methylphenyl silicone resin; and a resin such as an acrylic resin, a polyester resin and an epoxy resin which are modified by silicone. From a viewpoint of resistance to a solvent in the formation of the coating resin layer, which will be described later, and mechanical stability, it is preferable to use a cured product of the methyl silicone resin.

When the magnetic body is coated with the silicone resin, a curing catalyst that is generally used may be used as needed. For example, such compounds can be used as a tin compound, a titanium compound, a zinc compound, an aluminum compound, an iron compound, a cobalt compound and a manganese compound. Among these compounds, the tin compound and the titanium compound can be used as particularly preferable catalysts, because of having a large action of improving hardness of the silicone resin.

Examples of the method of coating the magnetic body with the silicone resin includes a method of diluting a resin component with a solvent and adding a magnetic body particle to the diluted liquid. The solvent which is used here may be any solvent that can dissolve the resin component. Specifically, one or a plurality of mixed solvents can be selected from organic solvents such as toluene, xylene, butyl cellosolve acetate, methyl ethyl ketone, methyl isobutyl ketone and methanol, as needed. Examples of the method of distributing the resin component which has been diluted by a solvent, on the surface of the magnetic body particles, include a method of distributing the resin component on the surfaces of the magnetic bodies with a coating method such as a dipping method, a spraying method, a brush coating method, a fluidized bed method and a kneading method, and then volatilizing the solvent. A resin layer is formed by volatilizing the solvent, then raising the temperature according to curing characteristics of the silicone resin, and thereby causing a curing reaction.

It is preferable that the silicone resin distributed on the surfaces of the magnetic bodies has a thickness of 30 nm or larger and 300 nm or smaller. When thickness of the silicone resin is 30 nm or larger, it is considered that frequency of contact between the silica particles and the magnetic bodies is reduced due to the surfaces of the magnetic bodies which is sufficiently covered, and it becomes easier to exhibit an effect of improving the charged amount stability in a high-humidity environment. In addition, when the thickness is 300 nm or smaller, it is considered that the silicone resin can prevent a resistance of the carrier from becoming excessively high, and it becomes easier to exhibit an action of preventing the charged amount of the toner from becoming excessively large under the low-humidity environment.

In the magnetic carrier for electrostatic charge image development of the present disclosure, it is preferable that the magnetic core particle has a structure in which the silicone resin is filled in pores of the magnetic particle having the pores. By doing this, it is possible to further suppress contamination in the image forming apparatus due to the toner scattering which is caused by a decrease in the charged amount of the toner under a high-humidity environment over a longer period of use.

Examples of the method for filling the inside of the magnetic body particle having the pore with the resin component include a method of diluting the resin component in a solvent, and adding the magnetic body particles having the pores into the diluted liquid. The solvent which is used here may be any solvent that can dissolve each resin component. Specifically, one or a plurality of mixed solvents can be selected from organic solvents such as toluene, xylene, butyl cellosolve acetate, methyl ethyl ketone, methyl isobutyl ketone and methanol, as needed. Examples of the method of adding the resin component which has been diluted by a solvent, into the inside of the magnetic body particles, include a method of allowing the inside of the magnetic body particles impregnated with the resin component, by a coating method such as a dipping method, a spraying method, a brush coating method, a fluidized bed method and a kneading method, and then volatilizing the solvent.

In this case, it is acceptable to perform an operation of promoting the filling of the inside of the pore with the resin component, by reducing a pressure of the solution according to viscosity characteristics of the resin. The resin layer is formed by volatilizing the solvent, then raising the temperature according to the curing characteristics of the silicone resin, and thereby causing a curing reaction. If necessary, it is acceptable to adopt methods of distributing the silicone resin inside and on the surface of the magnetic body particles at the same time, by adjusting the amount of the silicone resin to be added, or it is also acceptable to adopt methods of filling the inside of the particle with the silicone resin, and then coating the magnetic body with the silicone resin in a same way as the previously described methods.

In the magnetic carrier for electrostatic charge image development according to the present disclosure, it is preferable that coverage with the silicone resin on the surfaces of the magnetic core particles is 60% or more, which is measured by a method that will be described later. By doing this, the ratio of the magnetic body covered with the silicone resin is higher, the frequency of contact between the silica particles and the magnetic bodies is lower; and the carrier becomes enabled to keep the charged amount high particularly in a high-humidity environment. In addition, it is possible to further suppress a contamination in the image forming apparatus due to the toner scattering which is caused by a decrease in the charged amount of the toner under a high-humidity environment. It is more preferable that a coverage with the silicone resin is 70% or larger.

When an abundance ratio of silicon atoms on the surface of the magnetic core particle is defined as Si_atm (atomic %), and a total abundance ratio of iron, manganese, magnesium, strontium, copper, zinc, nickel and cobalt atoms is defined as M_atm (atomic %), it is preferable that the Si_atm and the M_atm satisfy the following Expression (2).

$$M\_atm / Si\_atm < 0.4 \qquad Expression ( 2 )$$

By doing this, a ratio of the magnetic body covered with the silicone resin increases, and frequency of contact between the silica particles and the magnetic bodies decreases; and thereby, the charged amount can be kept high particularly in a high-humidity environment. In addition, it is possible to further suppress the contamination in the image forming apparatus due to the toner scattering caused by a decrease in the charged amount of the toner under a high-humidity environment.

It is preferable that volume-average particle diameter (D50) of the magnetic core particles is 20 μm or larger and 80 μm or smaller; and then, the magnetic core particles can be uniformly coated with the coating resin, the adhesion of the magnetic carrier is prevented, and the density of a magnetic brush for the developer for obtaining a high-quality image is moderated.

As for the specific resistance of the magnetic core particle, it is preferable that the specific resistance value at an electric field intensity of 1000 (V/cm) is at least 1.0×10⁵ (Ω·cm) or higher and 1.0×10¹⁴ (Ω·cm) or lower; and then, satisfactory developability becomes to be obtained.

### <Coating Resin Layer>

The carrier according to the present disclosure has a coating resin layer that covers the surface of the magnetic core particle. The coating resin layer contains a coating resin formed of a vinyl-based resin as a binder resin, and contains a silica particle.

It is preferable that an average layer thickness of the coating resin layer is 100 nm or larger, and then, the coating layer can decrease the frequency of contact between the magnetic body and the silica particle, and can easily ensure the charged amount of the toner particularly in a high-humidity environment. In addition, when the thickness is larger than 3000 nm, the coating layer tends to easily increase the charge under a low-humidity environment, and accordingly, it is preferable that the thickness is 3000 nm or smaller. It is more preferable that the thickness is 1500 nm or smaller, because the thickness can more effectively suppress an increase of the charge under the low-humidity environment.

The methods for forming the coating resin layer on the surface of the magnetic core particle are not particularly limited, and known methods can be used. For example, one of the methods is a dipping method which volatilizes the solvent while stirring the magnetic core particle and a coating resin solution, and coats the surface of the magnetic core with the coating resin. Specific examples thereof include a universal mixing and stirring machine (manufactured by Fuji Paudal Co., Ltd.) and a Nauta mixer (manufactured by Hosokawa Micron Corporation). Another one of the methods is also a method of spraying a coating resin solution from a spray nozzle while forming a fluidized bed, and coating the surface of the magnetic core particle with the coating resin.

Specific examples thereof include SPIRA COTA (manufactured by Okada Seiko Co., Ltd.) and SPIRA FLOW (manufactured by Freund Corporation). In addition, a method of coating the magnetic core particle with the coating resin in a particle state, by a dry method, is also known. Specific examples include a treatment method which uses an apparatus such as a hybridizer (manufactured by Nara Machinery Co., Ltd.), a mechanofusion (manufactured by Hosokawa Micron Corporation), a high flex gral (manufactured by Fukae Powtec Corporation), or a theta composer (manufactured by Tokuju Corporation).

In addition, the coating resin layer may contain a resin component other than the binder resin, and various additives other than the silica particle within such a range as not to impair effects of the present disclosure. Examples thereof include: charge controlling agents which include fine particles of resins such as an acrylic resin, a phenol resin and a melamine resin; and resistance controlling agents such as carbon black and fine particles of metals.

### <Coating Resin>

The coating resin is formed of a vinyl-based resin, and serves as the binder resin of the coating resin layer. The coating resin is not particularly limited as long as the resin is a polymer of a vinyl-based monomer, and a known resin can be used. Examples of the above monomer include usable known monomers which include: (meth)acrylic acid and esters; olefins; aromatic vinyl compounds such as styrene; and organic acids and esters having a vinyl group such as vinyl acetate. These may be used as a homopolymer or as a copolymer of a plurality of these. When the polymer is used as a copolymer, a form of random polymerization, block polymerization, graft polymerization, etc. can be selected as needed.

When mass of the vinyl-based resin component after having been held in the first environment for 5 hours is defined as M5, and when mass of the vinyl-based resin which has been held in the first environment for 5 hours, after having been held in the second environment for 5 hours is defined as M6, it is preferable that the M5 and the M6 satisfy the following Expression (4).

$$0 \leq ( M 5 - M 6 ) / M 5 \times 100 \leq 0.60 \qquad Expression ( 4 )$$

By doing this, content of moisture under a high-humidity environment becomes small, and the charge imparting ability to the toner under the high-humidity environment can be easily maintained at a high level. In addition, the contamination in the image forming apparatus due to the toner scattering caused by a decrease in the charged amount of the toner under a high-humidity environment can be further suppressed. For information, in the present disclosure, the M5 and the M6 can be confirmed with a use of a thermogravimetric analysis device, for example.

In the magnetic carrier for electrostatic charge image development according to the present disclosure, it is preferable for the vinyl-based resin to include a unit derived from a (meth)acrylic acid ester monomer, and is more preferable to be a copolymer containing at least one type of monomer containing a (meth)acrylic acid ester having a cyclic hydrocarbon group in a molecular structure. It is preferable to use a polymer having at least one or more types of (meth) acrylic acid esters as a monomer, from a view point of characteristics that the carrier has a low moisture absorption amount under a high-humidity environment and can maintain the charge imparting ability to the toner at a high level.

Furthermore, it is more preferable that at least one of the monomers to be used is a (meth)acrylic acid ester having an alicyclic hydrocarbon in the molecular structure, because an effect of reducing the moisture absorption amount under a high-humidity environment is more greatly expressed. By doing this, it is possible to further suppress the contamination in the image forming apparatus due to the toner scattering caused by a decrease in the charged amount of the toner under a high-humidity environment.

### <Silica Particle>

The carrier of the present disclosure contains a silica particle in the coating resin layer. The silica particle can be selected from known silica particles and can be used within such a range as not to impair the effects of the present disclosure, and examples thereof include a combustion method silica particle, a deflagration method silica particle, a sol-gel silica particle, a precipitation method silica particle, and a colloidal silica particle.

In the magnetic carrier for electrostatic charge image development of the present disclosure, when mass of the silica particle after having been held in the first environment for 5 hours is defined as M3, and when mass of the silica particle which has been held in the first environment for 5 hours, after having been held in the second environment for 5 hours, is defined as M4, it is preferable that the M3 and the M4 satisfy the following Expression (3).

$$3. \leq ( M 3 - M 4 ) / M 3 \times 100 \leq 10.0 \qquad Expression ( 3 )$$

By doing this, such an effect of suppressing a decrease in the image density caused by an excessive increase in the charged amount of the toner under a low-humidity environment becomes great. In addition, a decrease in the image density caused by an excessive increase in the charged amount of the toner in a low-humidity environment can be further suppressed. For information, in the present disclosure, the M3 and the M4 can be confirmed with a use of a thermogravimetric analysis device, for example.

The detailed mechanism of this is not clear, but it is assumed to be because the reduction amount of moisture in the low-humidity environment is large in a case where the high-humidity environment and the low-humidity environment are compared, such a state is induced that the negative property of the surface of the carrier in a low-humidity environment is higher, and an action of preventing the charged amount of the toner from becoming excessively large tends to be easily exhibited. It is more preferable configuration that the above mass reduction rate is 4% or larger, because the above effect can be more greatly exhibited.

In addition, it is preferable that the above mass reduction rate is 10% or smaller, because the carrier tends to easily sufficiently ensure the charged amount of the toner in the high-humidity environment. A more preferable range is 7% or smaller.

In the magnetic carrier for electrostatic charge image development according to the present disclosure, the silica particle is a silica particle (wet silica particle) which is produced by a wet method such as a sol-gel method or a precipitation method. By doing this, the reduction amount of moisture tends to become large in the low-humidity environment, in a case where the high-humidity environment and the low-humidity environment are compared with each other. In addition, it is possible to further suppress a decrease in the image density caused by an excessive increase in the charged amount of the toner in the low-humidity environment.

It is preferable that the surface of the silica particle is subjected to hydrophobization treatment as needed, because the effect of suppressing the charged amount of the toner from becoming excessive in a low-humidity environment tends to be easily exhibited. It is considered to be because when a surface of the silica particle is subjected to the hydrophobization treatment, the carrier tends to easily form a structure in which the silica particles are exposed to the surface of the coating resin layer, and in a case where the carrier is mixed with the toner and is used as a developer, contact frequency between the toner and the silica particles is improved.

Any known methods can be used for the surface treatment, and can be selected from a silane coupling agent, a titanate coupling agent, an aluminate coupling agent, etc., which have an alkyl group such as a methyl group, an ethyl group or a propyl group. It is preferable that the surface is treated by: a coupling agent such as various titanium coupling agents and silane coupling agents; a fatty acid and a metal salt thereof; a silicone oil; or a combination thereof.

Examples of the titanium coupling agent include tetrabutyl titanate, tetraoctyl titanate, isopropyl triisostearoyl titanate, isopropyl tridecyl benzene sulfonyl titanate and bis(dioctyl pyrophosphate) oxyacetate titanate.

In addition, examples of the silane coupling agent include γ-(2-aminoethyl)aminopropyl trimethoxy silane, γ-(2-aminoethyl)aminopropyl methyl dimethoxy silane, γ-methacryloxypropyl trimethoxy silane, N-β-(N-vinyl benzyl aminoethyl) γ-aminopropyl trimethoxy silane hydrochloride, hexamethyl disilazane, methyl trimethoxy silane, butyl trimethoxy silane, isobutyl trimethoxy silane, hexyl trimethoxy silane, octyl trimethoxy silane, decyl trimethoxy silane, dodecyl trimethoxy silane, phenyl trimethoxy silane, o-methylphenyl trimethoxy silane and p-methylphenyl trimethoxy silane.

Examples of the fatty acid include long-chain fatty acid such as undecylic acid, lauric acid, tridecylic acid, dodecylic acid, myristic acid, palmitic acid, pentadecylic acid, stearic acid, heptadecylic acid, arachidic acid, montanic acid, oleic acid, linoleic acid, and arachidonic acid. Examples of a metal of metal salts of the fatty acid include zinc, iron, magnesium, aluminum, calcium, sodium and lithium.

Examples of the silicone oil include dimethyl silicone oil, methylphenyl silicone oil, and amino-modified silicone oil.

Among these, silane coupling agents can be particularly suitably used, and it is a particularly suitable form to use a same surface treatment agent as the agent which is used for the surface treatment of the silica particle external additive contained in the toner, because an effect of preventing the charged amount of the toner from becoming excessively high under a low-humidity environment tends to be easily exhibited.

As for a work function of the silica particle, it is preferable that an absolute value of a difference in work function between the silica particle and the silica particle external additive contained in the toner which will be described later is 0.20 eV or smaller, because an effect of preventing the charged amount of the toner from becoming excessively high under a low-humidity environment tends to be easily exhibited. It is more preferable form that an absolute value of difference in the above work function is 0.10 eV or smaller.

In the magnetic carrier for electrostatic charge image development according to the present disclosure, it is preferable that a number of silanol groups present on the surface of the silica particle, per unit surface area of the silica particle is 1.0/nm² or larger and 2.0/nm² or smaller. By doing this, an effect of ensuring the high charged amount of the toner under a high-humidity environment becomes large.

Detailed mechanism of this effect is not clear, but it is assumed to be because when a number of highly polar silanol groups on the surface of the silica particle is small, affinity with the silicone resin on the surface of the magnetic core increases, and probability of the silica particles that are distributed in a vicinity of the magnetic body which is exposed decreases when the coating resin layer is formed, and thereby, frequency of the silica particles decreases which come into contact with the magnetic body. Examples of the method for reducing the number of silanol groups on the surface of the silica particle include performing the surface treatment with the previously described various coupling agents.

In addition, it is preferable that a number of silanol groups per unit surface area of the silica particle is 1.0/nm² or larger, because contamination of by-products derived from the surface treatment agent can be reduced.

In the magnetic carrier for electrostatic charge image development according to the present disclosure, it is preferable that a volume-average particle diameter of the silica particle is 50 nm or larger and 250 nm or smaller. When the volume-average particle diameter of the silica particle is 50 nm or larger, the silica particle tends to be easily exposed from the surface of the coating resin layer, and frequency of contact with the toner increases, and thereby, an effect of preventing excessive charging in a low-humidity environment increases. In addition, when the volume-average particle diameter is 250 nm or smaller, frequency of contact with the magnetic body can be reduced, and the charged amount can be sufficiently ensured even under a high-humidity environment. It is more preferable that the volume-average particle diameter is 200 nm or smaller, because an effect of improving the charged amount is further enhanced. In addition, when the volume-average particle diameter is 50 nm or larger and 250 nm or smaller, a decrease in the image density caused by an excessive increase in the charged amount of the toner in a low-humidity environment can be further suppressed.

### <Toner>

The carrier in the present disclosure can be used in combination with a toner which has been produced by a known method, without particular limitation. In general, general configuration is containing a binder resin for a toner base as a main component, and optionally containing a mold release agent, a coloring agent, a dispersion aid, and an inorganic particle. In particular, a negatively chargeable toner can be preferably used that has a structure in which single or a plurality of types of inorganic fine particles including the silica particle are attached to the surface of the toner base particle containing the binder resin as a main component, because the toner tends to easily exhibit an effect of suppressing an excessive increase in a charge of the toner in a low-humidity environment.

### <Binder Resin for Toner Base>

As the binder resin for the toner base of the toner, the following polymer, etc. can be used. Examples thereof include: homopolymers of styrene and substituted products thereof such as polystyrene, poly-p-chlorostyrene, and polyvinyl toluene; styrene-based copolymers such as a styrene-p-chlorostyrene copolymer, a styrene-vinyl toluene copolymer, a styrene-vinyl naphthalene copolymer, a styrene-acrylic acid ester copolymer, and a styrene-methacrylic acid ester copolymer; a styrene-based copolymer resin, a polyester resin, a hybrid resin in which a polyester resin and a vinyl-based resin are mixed or both are partially reacted; and polyvinyl chloride, a phenol resin, a natural modified phenol resin, a natural resin-modified maleic acid resin, an acrylic resin, a methacrylic resin, polyvinyl acetate, a silicone resin, a polyester resin, polyurethane, a polyamide resin, a furan resin, an epoxy resin, a xylene resin, a polyethylene resin and a polypropylene resin. Among these materials, it is preferable to use the polyester resin as a main component, from a viewpoint of low-temperature fixability.

Monomers which are used for a polyester unit of the polyester resin are polyhydric alcohols (alcohols having a valency of 2 or 3 or more), polyvalent carboxylic acids (carboxylic acids having a valency of 2 or 3 or more), acid anhydrides thereof, or lower alkyl esters thereof. Here, in order to prepare a branched polymer so as to develop “strain hardening”, it is effective to cause partial cross-linking in a molecule of an amorphous resin, and for this purpose, it is preferable to use a polyfunctional compound which has a valency of 3 or more. Accordingly, it is preferable that a raw material monomer of the polyester unit contains a carboxylic acid which has a valency of 3 or more, an acid anhydride thereof or a lower alkyl ester thereof, and/or an alcohol which has a valency of 3 or more.

Usable polyhydric alcohol monomers to be used in the polyester unit of the polyester resin are the following polyhydric alcohol monomers.

Examples of dihydric alcohol components which are preferably used include: ethylene glycol, propylene glycol, 1,3-butanediol, 1,4-butanediol, 2,3-butanediol, diethylene glycol, tri ethylene glycol, 1,5-pentanediol, 1,6-hexanediol, neopentyl glycol, 2-ethyl-1,3-hexanediol, and hydrogenated bisphenol A; bisphenol represented by the following formula (A) and derivatives thereof;

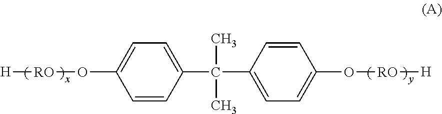

(wherein R is an ethylene or propylene group, x and y are each an integer of 0 or larger, and an average value of x+y is 0 or larger and 10 or smaller); and

diols expressed by the following formula (B).

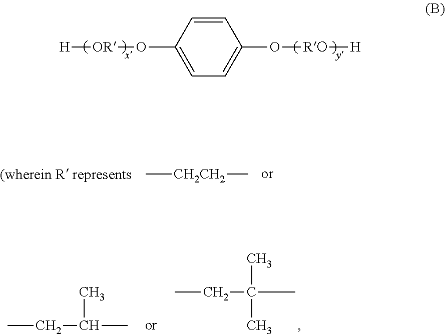

x′ and y′ are integers of 0 or larger, and an average value of x′+y′ is 0 or larger and 10 or smaller).

Examples of the alcohol component which has a valency of 3 or more include: sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethyl benzene. Among these alcohol components, glycerol, trimethylolpropane and pentaerythritol are preferably used. These dihydric alcohols and alcohols which has valencies of three or more may be used alone or in combination of two or more thereof.

As a polyvalent carboxylic acid monomer to be used in the polyester unit of the polyester resin, the following polyvalent carboxylic acid monomers can be used.

Examples of the divalent carboxylic acid components include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenyl succinic acid, isododecenyl succinic acid, n-dodecyl succinic acid, isododecyl succinic acid, n-octenyl succinic acid, n-octyl succinic acid, isooctenyl succinic acid, isooctyl succinic acid, anhydrides of these acids, and lower alkyl esters thereof. Among these monomers, maleic acid, fumaric acid, terephthalic acid, and n-dodecenyl succinic acid are preferably used.

Examples of the carboxylic acids having a valency of 3 or more, an acid anhydride thereof, or a lower alkyl ester thereof include: 1,2,4-benzene tricarboxylic acid, 2,5,7-naphthalene tricarboxylic acid, 1,2,4-naphthalene tricarboxylic acid, 1,2,4-butane tricarboxylic acid, 1,2,5-hexane tricarboxylic acid, 1,3-dicarboxyl-2-methyl-2-methylene carboxypropane, 1,2,4-cyclohexane tricarboxylic acid, tetra(methylene carboxyl) methane, 1,2,7,8-octane tetracarboxylic acid, pyromellitic acid, empol trimer acid, acid anhydrides thereof, or lower alkyl esters thereof. Among these, 1,2,4-benzene tricarboxylic acid, in other words, trimellitic acid or a derivative thereof is particularly preferably used, because of being inexpensive and easy in the reaction control. These divalent carboxylic acids and carboxylic acids having three or more valencies can be used alone or in combination of two or more thereof.

A method for producing the polyester unit of the present disclosure is not particularly limited, and a known method can be used. For example, the alcohol monomer and the carboxylic acid monomer which are previously described are charged at a same time, and are polymerized through an esterification reaction or a transesterification reaction, and a condensation reaction; and a polyester resin is produced. In addition, the polymerization temperature is not particularly limited, but is preferably in a range of 180° C. or higher and 290° C. or lower. When the polyester unit is polymerized, a polymerization catalyst can be used such as a titanium-based catalyst, a tin-based catalyst, zinc acetate, antimony trioxide and germanium dioxide. In particular, the binder resin for the toner base of the present disclosure is more preferably a polyester unit which is polymerized with a use of a tin-based catalyst.

In addition, it is preferable that an acid value of the polyester resin is 5 mgKOH/g or larger and 20 mgKOH/g or smaller, and that a hydroxyl value is 20 mgKOH/g or larger and 70 mgKOH/g or smaller, from the viewpoint of a fogging property, because an amount of moisture adsorption under a high-temperature and high-humidity environment can be suppressed, and a non-electrostatic adhesion force can be suppressed to a low level.

In addition, the binder resin for the toner base may be a mixture of a low molecular weight resin and a high molecular weight resin. A content ratio of the high molecular weight resin to a low molecular weight resin is preferably 40/60 or larger and 85/15 or smaller on a mass basis, from a viewpoint of low-temperature fixability and hot offset resistance.

### <Mold Release Agent>

The toner may contain a mold release agent in order to improve separability from a member in thermal fixing. Examples thereof include: hydrocarbon-based waxes such as low molecular weight polyethylene, low molecular weight polypropylene, an alkylene copolymer, microcrystalline wax, paraffin wax, and Fischer-Tropsch wax; oxides of hydrocarbon-based waxes such as oxidized polyethylene wax, or block copolymers thereof, waxes which contain a fatty acid ester as a main component, such as carnauba wax; and a compound obtained by partially or entirely deoxidizing a fatty acid ester, such as deoxidized carnauba wax.

Furthermore, the examples include: saturated linear fatty acids such as palmitic acid, stearic acid and montanic acid; unsaturated fatty acids such as brassidic acid, eleostearic acid and valinaric acid; saturated alcohols such as stearyl alcohol, aralkyl alcohol, behenyl alcohol, carnauba alcohol, ceryl alcohol and melissyl alcohol; polyhydric alcohols such as sorbitol; esters of fatty acids such as palmitic acid, stearic acid, behenic acid and montanic acid, with alcohols such as stearyl alcohol, aralkyl alcohol, behenyl alcohol, carnauba alcohol, ceryl alcohol and melissyl alcohol; fatty acid amides such as linoleic acid amide, oleic acid amide and lauric acid amide; saturated fatty acid bisamides such as methylene bisstearic acid amide, ethylene biscapric acid amide, ethylene bislauric acid amide, and hexamethylene bisstearic acid amide; unsaturated fatty acid amides such as ethylene bis-oleic acid amide, hexamethylene bis-oleic acid amide, N,N′-dioleyl adipic acid amide, and N,N′-dioleyl sebacic acid amide; aromatic bisamides such as m-xylene bisstearic acid amide, and N,N′-distearyl isophthalic acid amide; aliphatic metal salts (generally referred to as metal soaps) such as calcium stearate, calcium laurate, zinc stearate and magnesium stearate; waxes obtained by grafting an aliphatic hydrocarbon-based wax with a use of a vinyl-based monomer such as styrene or acrylic acid; a partially esterified product of a fatty acid and a polyhydric alcohol, such as behenic acid monoglyceride; and methyl ester compounds having a hydroxyl group, which are obtained by hydrogenation of vegetable oils and fats.

Among these waxes, hydrocarbon-based waxes such as paraffin wax and Fischer-Tropsch wax, and fatty acid ester-based waxes such as carnauba wax are preferable, from a viewpoint of improving low-temperature fixability and fixing separability. In the present disclosure, hydrocarbon-based waxes are more preferable, from a viewpoint of further improving hot offset resistance.

In the present disclosure, it is preferable that the wax is used in an amount of 3 parts by mass or more and 8 parts by mass or less, relative to 100 parts by mass of the binder resin for the toner base.

In addition, it is preferable that a peak temperature of maximum endothermic peak of the wax is 45° C. or higher and 140° C. or lower, in an endothermic curve when temperature rises, which is measured with a differential scanning calorimetry (DSC) device. It is preferable that a peak temperature of the maximum endothermic peak of the wax is within the above range, because both storage stability and the hot offset resistance of the toner can be achieved.

### <Coloring Agent>

The toner particle in the present disclosure may contain a coloring agent. Examples of the coloring agent include the following.

Examples of black coloring agent include carbon black, and also include an agent which has been toned to black with the use of a yellow coloring agent, a magenta coloring agent, and a cyan coloring agent. A pigment may be used alone as the coloring agent, but it is more preferable to use a dye and a pigment in combination to improve sharpness of the image, from a viewpoint of image quality of full-color image.

Examples of pigments for magenta toners include; C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269 and 282; C. I. Pigment Violet 19; and C. I. Vat Red 1, 2, 10, 13, 15, 23, 29 and 35.

Examples of the dye for magenta toner include; oil-soluble dyes such as C. I. Solvent Red 1, 3, 8, 23, 24, 25, 27, 30, 49, 81, 82, 83, 84, 100, 109 and 121, C. I. Disperse Red 9, C. I. Solvent Violet 8, 13, 14, 21 and 27, and C. I. Disperse Violet 1; and basic dyes such as C. I. Basic Red 1, 2, 9, 12, 13, 14, 15, 17, 18, 22, 23, 24, 27, 29, 32, 34, 35, 36, 37, 38, 39 and 40, and C. I. Basic Violet 1, 3, 7, 10, 14, 15, 21, 25, 26, 27 and 28.

Examples of pigments for cyan toners include: C. I. Pigment Blue 2, 3, 15:2, 15:3, 15:4, 16 and 17; C. I. Vat Blue 6; C. I. Acid Blue 45; and copper phthalocyanine pigments in which 1 to 5 phthalimidomethyl groups are substituted in the phthalocyanine skeleton.

Examples of a dye for a cyan toner include C. I. Solvent Blue 70.

Examples of pigments for yellow toners include: C. I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181 and 185; and C. I. Vat Yellow 1, 3 and 20.

Examples of the dye for the yellow toner include C. I. Solvent Yellow 162.

These coloring agents can be used alone or in combination, and further can be used in a form of a solid solution. The coloring agent is selected in view of hue angle, chroma, lightness, light resistance, OHP transparency, and dispersibility to the toner.

It is preferable that a content of the coloring agent is 0.1 parts by mass or more and 30.0 parts by mass or less, with respect to a total amount of the resin component.

### <Dispersion Aid>

In order to disperse mold release agent in the resin, it is preferable that the toner particle contains a dispersion aid. As the dispersion aid, a known dispersion aid can be used, but in a case where a hydrocarbon-based wax is contained as the mold release agent, it is preferable to contain a polymer which has a structure obtained by reacting a vinyl-based resin component with a hydrocarbon compound, in order to disperse the wax in the resin. Among the polymers, it is preferable to contain a graft polymer in which a vinyl-based monomer is graft-polymerized with a polyolefin.

When the polymer is contained, compatibility between the wax and the resin is promoted, and the toner resists causing adverse effects such as charging failure and member contamination due to wax dispersion failure. In addition, it is preferable that the content of the dispersion aid is 1.0 parts by mass or more and 15 parts by mass or less with respect to 100 parts by mass of the binder resin for the toner base. When the content is within this range, the dispersed condition of the wax in amorphous resin tends to easily become uniform. The polyolefin is not particularly limited as long as the polyolefin is a polymer or copolymer of an unsaturated hydrocarbon, and various polyolefins can be used. Particularly, a polyethylene-based material and a polypropylene-based material are preferably used. A plurality of these materials may be used.

Examples of the monomer which have a vinyl-based group include styrene-based units which include styrene and derivatives thereof, such as styrene, o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene and p-n-dodecylstyrene.

In addition, examples of the monomer which have the vinyl-based group include vinyl-based units containing an N atom, which include: amino group-containing a-methylene aliphatic monocarboxylic acid esters such as dimethylaminoethyl methacrylate and diethylaminoethyl methacrylate; and derivatives of acrylic acid or methacrylic acid, such as acrylonitrile, methacrylonitrile and acrylamide.

In addition, examples of the monomer which have the vinyl-based group include vinyl-based units containing a carboxyl group, which include: unsaturated dibasic acids such as maleic acid, citraconic acid, itaconic acid, alkenylsuccinic acid, fumaric acid, and mesaconic acid; unsaturated dibasic acid anhydrides such as maleic anhydride, citraconic anhydride, itaconic anhydride, and alkenylsuccinic anhydride; half esters of unsaturated dibasic acids such as maleic acid methyl half ester, maleic acid ethyl half ester, maleic acid butyl half ester, methyl citraconate half ester, ethyl citraconate half ester, butyl citraconate half ester, methyl itaconate half ester, methyl alkenylsuccinate half ester, methyl fumarate half ester, and methyl mesaconate half ester; unsaturated dibasic acid esters such as dimethylmaleic acid ester and dimethylfumaric acid ester; α,β-unsaturated acids such as acrylic acid, methacrylic acid, crotonic acid, and cinnamic acid; α,β-unsaturated acid anhydrides such as crotonic acid anhydride and cinnamic acid anhydride; anhydrides of the α,β-unsaturated acids and lower fatty acids; and alkenyl malonic acid, alkenyl glutaric acid, alkenyl adipic acid, acid anhydrides thereof, and monoesters thereof.

In addition, examples of the monomer which have the vinyl-based group include vinyl-based units containing a hydroxy group, which include: esters of acrylic acid or methacrylic acid, such as 2-hydroxyethyl acrylate, 2-hydroxyethyl methacrylate, and 2-hydroxypropyl methacrylate; and 4-(1-hydroxy-1-methylbutyl) styrene, and 4-(1-hydroxy-1-methylhexyl) styrene.

In addition, examples of the monomer which have the vinyl-based group include ester units formed of acrylic acid esters, which include methyl acrylate, ethyl acrylate, n-butyl acrylate, isobutyl acrylate, propyl acrylate, n-octyl acrylate, dodecyl acrylate, 2-ethylhexyl acrylate, stearyl acrylate, 2-chloroethyl acrylate, and phenyl acrylate.

In addition, examples of the monomer which have the vinyl-based group include: ester units formed of methacrylic acid esters such as a-methylene aliphatic monocarboxylic acid esters, such as cyclohexyl methacrylate, methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, and diethylaminoethyl methacrylate. A plurality of these monomers may be used.

The above dispersion aid can be obtained by a known method such as a reaction between the above-described polymers, or a reaction between a monomer of one polymer and the other polymer.

### <Inorganic Fine Particle>

It is preferable that the toner contains an inorganic fine particle mainly for a purpose of enhancing fluidity and chargeability, and it is preferable that the inorganic fine particle is in a form of being attached to the toner surface. In particular, a negatively chargeable toner in a form in which silica particles are added to the surface is preferable, so as to sufficiently exhibit the effect of suppressing excessive charging in a low-humidity environment, in the present disclosure.

As the inorganic fine particles as spacer particles for enhancing releasability of the toner from the magnetic carriers, silica particle external additives are preferable in which a maximum peak particle diameter based on number distribution standard is 80 nm or larger and 200 nm or smaller. In order to more satisfactorily suppress detachment from the toner while functioning as spacer particles, it is more preferable that the maximum peak particle diameter is 100 nm or larger and 150 nm or smaller.

In order to improve the fluidity of the toner, it is preferable that the inorganic fine particles are contained in which the maximum peak particle diameter based on the number distribution standard is 20 nm or larger and 50 nm or smaller, and it is also preferable form that the inorganic fine particles are used in combination with the silica particle external additives.

Furthermore, another external additive may be added to the toner particle for the purpose of improving fluidity and transferability. It is preferable that the external additive which is externally added to the surface of the toner particle contains an inorganic fine particle such as titanium oxide, alumina oxide, strontium titanate and barium titanate; and a plurality of types thereof may be used in combination.

A total content of the external additives is preferably 0.3 parts by mass or more and 5.0 parts by mass or less, more preferably 0.8 parts by mass or more and 4.0 parts by mass or less, with respect to 100 parts by mass of the toner particle. Among them, a content of silica particles of which the maximum peak particle diameter based on number distribution standard is 80 nm or larger and 200 nm or smaller is preferably 0.1 parts by mass or more and 2.5 parts by mass or less, more preferably 0.5 parts by mass or more and 2.0 parts by mass or less. When the content is in this range, an effect as the spacer particle becomes more remarkable.

In addition, it is preferable that the surface of the silica particle and an inorganic fine particle which are used as the external additive is subjected to hydrophobization treatment. It is preferable that the hydrophobization treatment is performed by a coupling agent such as various titanium coupling agents and silane coupling agents, a fatty acid and a metal salt thereof, a silicone oil, or a combination thereof.

It is preferable that the hydrophobization treatment is performed by adding a hydrophobization treatment agent to the particle to be treated in an amount of 1% by mass or more and 30% by mass or less (more preferably 3% by mass or more and 7% by mass or less) with respect to particles to be treated, and covering particles to be treated.

A degree of hydrophobization of the external additive which has been subjected to the hydrophobization treatment is not particularly limited, but it is preferable that a degree of hydrophobization after the treatment is 40 or larger and 98 or smaller, for example. The degree of hydrophobization indicates wettability of a sample to methanol, and is an index of hydrophobicity.

### <Method for Producing Toner Particle>

The method for producing the toner particle is not particularly limited, and a known method can be used such as a kneading and pulverizing method, a suspension polymerization method, a dissolution suspension method, an emulsion aggregation method, and a dispersion polymerization method. Among these methods, the kneading and pulverizing method is preferable from a viewpoint of controlling dispersion condition of a mold release agent and a crystalline resin. In other words, it is preferable that the toner particle is pulverized toner particle. A procedure for producing the toner by the kneading and pulverizing method will be described below.

The kneading and pulverizing method includes: for example, a raw material mixing step of mixing a mold release agent, a crystalline polyester and an amorphous polyester as a binder resin for a toner base, and other components such as a coloring agent and a charge control agent as needed; a step of melt-kneading the mixed raw materials, and obtaining a resin composition; and a step of pulverizing the obtained resin composition and obtaining the toner particles.

In the raw material mixing step, predetermined amounts of materials constituting the toner particles are weighed, which are, for example, the binder resin for the toner base, the mold release agent, and other components such as the coloring agent and a charge control agent as needed, and are blended; and are mixed. Examples of a mixing apparatus include a double cone mixer, a V-type mixer, a drum-type mixer, a super mixer, a Henschel mixer, a Nauta mixer, and a Mechano Hybrid (manufactured by Nippon Coke & Engineering Co., Ltd.).

Next, the mixed materials are melt-kneaded, and the materials are dispersed in the binder resin for the toner base. In the melt-kneading step, a batch-type kneading machine such as a pressure kneader or a Banbury mixer, or a continuous kneading machine can be used, and a single-screw or twin-screw extruding machine is mainly used because of an advantage of being capable of continuous production. Examples thereof include a KTK type twin-screw extruding machine (manufactured by Kobe Steel, Ltd.), a TEM type twin-screw extruding machine (manufactured by Toshiba Machine Co., Ltd.), a PCM kneading machine (manufactured by Ikegai Ironworks Corp.), a twin-screw extruding machine (manufactured by KCK Corporation), a co-kneader (manufactured by Buss), and a kneadex (manufactured by Nippon Coke & Engineering Co., Ltd.). Furthermore, the resin composition obtained by melt-kneading may be rolled with a two-roll mill, etc., and be cooled with water, etc. in a cooling step.

Next, the cooled resin composition is pulverized to a desired particle diameter in a pulverization step. In the pulverization step, the resultant is coarsely pulverized with a pulverizing machine such as a crusher, a hammer mill and a feather mill. After that, the resultant is finely pulverized with, for example, a Kryptron system (manufactured by Kawasaki Heavy Industries, Ltd.), a Super Rotor (manufactured by Nisshin Engineering Inc.), a Turbo Mill (manufactured by Freund-Turbo Corporation), or a fine pulverizer by an air jet system.

After that, the resultant is classified as needed, with a use of a classifier or a sieving machine such as an inertial classification type Elbow-Jet (manufactured by Nittetsu Mining Co., Ltd.), a centrifugal classification type Turboplex (manufactured by Hosokawa Micron Corporation), a TSP separator (manufactured by Hosokawa Micron Corporation), and Faculty (manufactured by Hosokawa Micron Corporation).

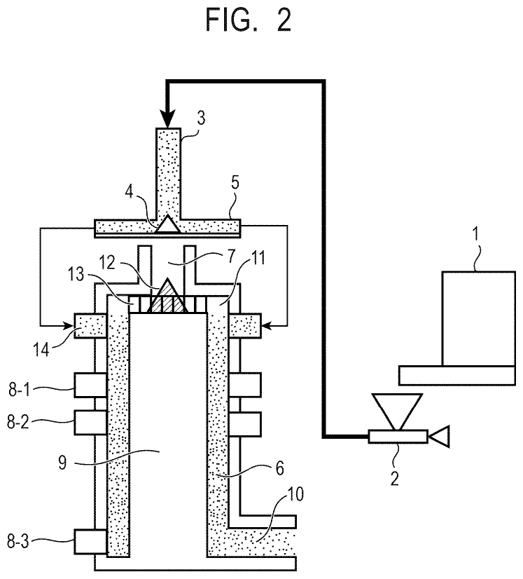

After that, in order to appropriately cover the surface of the toner particle with a mold release agent, it is preferable to perform a surface treatment of the toner particle by heating, from a viewpoint of suppressing blooming. For example, it is also possible to perform the surface treatment by hot air with a use of a surface treatment apparatus shown in FIG. 2.

The surface treatment with the use of the surface treatment apparatus shown in FIG. 2 will be described below.

A mixture which has been supplied in a fixed quantity by raw material fixed quantity supplying means 1 is guided to an introduction pipe 3 which is installed on a vertical line of the raw material fixed quantity supplying means by a compressed gas which has been adjusted by a compressed gas adjusting means 2. The mixture which has passed through the introduction pipe 3 is uniformly dispersed by a conical protruding member 4 that is provided at the center of the raw material fixed quantity supplying means, is guided to supply pipes 5 in eight directions, which extend radially, and is guided to a treatment chamber 6 in which heat treatment is performed.

At this time, a flow of the mixture that has been supplied to the treatment chamber 6 is regulated by regulating means 9 for regulating the flow of the mixture, which is provided in the treatment chamber 6. Because of this, the mixture that has been supplied to the treatment chamber is heat-treated while swirling in the treatment chamber 6, and is then cooled.

The hot air for heat-treating the supplied mixture is supplied from hot air supplying means 7 through a distribution member 12, and the hot air is spirally swirled and introduced into the treatment chamber 6, by the swirling member 13 for swirling the hot air. As for a configuration thereof, the swirling member 13 for swirling the hot air has a plurality of blades, and the swirling of the hot air can be controlled by a number of blades and an angle thereof.

It is preferable that a temperature of the hot air which is supplied into the treatment chamber 6 is 100° C. to 300° C. at a hot air supplying means outlet 11. When the temperature at the hot air supplying means outlet 11 is in the above range, it becomes possible to uniformly spheroidize toner particles while preventing fusion and coalescence of the toner particles due to excessive heating of the mixture.

The heat-treated toner particles are further cooled by cold air which is supplied from cold air supplying means 8-1, 8-2, and 8-3. It is preferable that a temperature of the cold air is −20° C. to 30° C., which is supplied from the cold air supplying means 8-1, 8-2, and 8-3. When the temperature of the cold air is in the above range, the surface treatment apparatus can efficiently cool the heat-treated toner particles, and can prevent the fusion and coalescence of the heat-treated toner particles, without hindering a uniform spheroidization treatment of the mixture. It is preferable that absolute water content of the cold air is 0.5 g/m³ or more and 15.0 g/m³ or less.

Next, the cooled heat-treated toner particles are collected by collecting means 10 at a lower end of the treatment chamber 6. For information, a blower (not shown) is provided at an end of the collecting means 10, and is configured to suck and convey the cooled heat-treated toner particles.

In addition, a powder particle supply port 14 is provided so that the swirling direction of the supplied mixture and the swirling direction of the hot air become a same direction, and the collecting means 10 of the surface treatment apparatus is provided on an outer periphery of the treatment chamber 6 so as to maintain the swirling direction of the swirled powder particles. Furthermore, the cold air which is supplied from the cold air supplying means 8-1, 8-2 and 8-3 is configured to be supplied from the outer peripheral portion of the apparatus to the inner peripheral surface of the treatment chamber 6 in the horizontal and tangential direction.

The swirling direction of the toner particles supplied from the powder supply port is a same direction as all of the directions of the swirling direction of the cold air supplied from the cold air supply unit 8, and the swirling direction of the hot air which is supplied from the hot air supplying means 7. Because of this, a turbulent flow does not occur in the treatment chamber 6, the swirling flow in the apparatus is strengthened, a strong centrifugal force is applied to the toner particles, and dispersibility of the toner particles is further improved; and accordingly, such toner particles can be obtained that shape is uniform and a number of coalesced particles is small.

When an average circularity of the toner particles is 0.950 or larger and 0.980 or smaller, the surface of the toner particles tends to be easily appropriately covered with the mold release agent.

After that, the surface of the toner particle is subjected to an external addition treatment with an external additive such as a silica fine particle, and the toner is obtained. Examples of the method for externally adding the external additive include a method of blending the classified toner and various known external additives in predetermined amounts, and stirring and mixing the mixture with a use of a mixing apparatus such as a double cone mixer, a V-type mixer, a drum-type mixer, a super mixer, a Henschel mixer, a Nauta mixer, Mechano Hybrid (manufactured by Nippon Coke & Engineering Co., Ltd.), and Nobilta (manufactured by Hosokawa Micron Corporation), as an external addition machine.

### <Developer>

In a case where the carrier of the present disclosure is mixed with a toner and used as a two-component developer, when a mixing ratio of the magnetic carrier is set to 2% by mass or larger and 15% by mass or smaller, and preferably 4% by mass or larger and 13% by mass or smaller as toner concentration in the developer, usually, satisfactory results tend to be easily obtained. When the toner concentration is less than 2% by mass, image density tends to be easily decreased, and when the toner concentration exceeds 15% by mass, fogging and toner scattering tend to easily occur.

In addition, in a replenishment developer for replenishing a developing device according to a decrease in the toner concentration of the two-component developer in the developing device, it is preferable that an amount of the toner is 2 parts by mass or more and 50 parts by mass or less with respect to 1 part by mass of the replenishment magnetic carrier. When the content is in the above range, even in a case where images which have a high image ratio are continuously output over a long period of time, a decrease in the charged amount of the toner is less likely to occur, and scattering of the toner can be suppressed; and accordingly, the above range is preferable.

The methods for measuring various physical properties of the carrier, raw materials and intermediates will be described below.

<Method for Separating Magnetic Core Particle from Carrier>

To 10 g of the carrier, 100 mL of methyl isobutyl ketone was added, and the mixture was subjected to ultrasonic cleaning at an output of 60 kHz for 15 minutes. Only a solid component was separated with a use of a filter paper of which standard of a retention particle size is 7 μm; and then, 100 mL of toluene was added thereto again, and a similar operation of cleaning and filtration was repeated two additional times. The obtained solid was completely dried with a use of a vacuum dryer, and the magnetic core particle was obtained.

<Method for Separating Silica Particle from Carrier>

To 10 g of the carrier, 10 mL of methyl isobutyl ketone was added, and the mixture was subjected to ultrasonic cleaning at an output of 60 kHz for 15 minutes. A liquid phase was collected by decantation, and then, 10 mL of toluene was added thereto again, and a similar operation of cleaning and collection of the liquid phase was repeated at two additional times. All the collected liquid phases were combined and the magnetic body was completely removed with a use of a permanent magnet.

The obtained liquid phase was charged into a centrifugal separator, rotation of 15000 rpm was applied to the centrifugal machine for 2 hours, and thereby, the solid components were separated. To the obtained solid components, 20 mL of tetrahydrofuran was added, and ultrasonic waves were applied to dissolve or disperse all the solid components in the liquid. The obtained liquid was charged into a centrifugal machine, rotation of 15000 rpm was applied to a centrifugal machine for 2 hours, and the solid components were separated; and the solid components were completely dried with the use of a vacuum dryer. A same operation of charging tetrahydrofuran, centrifuging and drying was repeated two additional times to the obtained solid component, and then, the resultant was subjected to vacuum drying at 120° C. for 24 hours; and the silica particle was obtained.

<Method for Separating Coating Resin from Carrier>

To 10 g of the carrier, 10 mL of methyl isobutyl ketone was added, and the mixture was subjected to the ultrasonic cleaning at an output of 60 kHz for 15 minutes. The liquid phase was collected by decantation, and then, 10 mL of toluene was added thereto again, and a similar operation of cleaning and collection of the liquid phase was repeated at two additional times. All the collected liquid phases were combined and the magnetic body was completely removed with the use of a permanent magnet.

The obtained liquid phase was charged into a centrifugal machine, rotation of 15000 rpm was applied to the centrifugal machine for 2 hours, and the solid component was separated. Such an operation was repeated at three times as to concentrate a solvent of the obtained liquid phase by distillation under reduced pressure until volume of the liquid became about 1 mL, add 15 mL of n-hexane thereto, filter off the precipitated solid component with a filter paper of which standard of a retention particle diameter is 1 μm, and then clean the resultant with 15 mL of n-hexane. The obtained solid component was completely dried by a vacuum dryer, and a coating resin was obtained.

<Method for Separating Silica-Based External Additive from Toner>

Sucrose (Kishida Chemical Co., Ltd.) in an amount of 160 g was added to 100 mL of ion-exchanged water, and was dissolved while being heated with hot water, and a sucrose solution was prepared. A dispersion liquid was prepared by mixing 31 g of a sucrose concentrate with 6 mL of Contaminon N (10% by mass of aqueous solution of a neutral detergent of pH 7 for cleaning precision measurement equipment, which is formed of a nonionic surface-active agent, an anionic surface-active agent, and an organic builder; and is produced by Fujifilm Wako Pure Chemical Corporation).

To this dispersion liquid, 1 g of the toner was added, the resultant was subjected to ultrasonic cleaning at output of 60 kHz for 15 minutes, thereby the toner particles were completely dispersed in the dispersion liquid, and the toner dispersion liquid was obtained. The obtained toner dispersion liquid was centrifuged by a centrifugal machine under conditions of 3500 rpm for 30 minutes.

After the centrifugal separation, the toner existed in a uppermost layer, and the external additive existed in the aqueous solution side of a lower layer. The lower aqueous solution was collected and centrifuged, and sucrose and the external additive were separated. If necessary, the centrifugation was repeated, separation was sufficiently performed, and then the dispersion liquid was dried; and a mixture of inorganic particles was obtained. The obtained mixture of the inorganic particles was fractionated by a centrifugal separation method, and a silica-based external additive was obtained.

### <Method for Measuring Volume-Average Particle Diameter (D50) of Magnetic Carriers and Magnetic Core Particles>

Particle size distribution was measured with a use of a laser diffraction/scattering type particle size distribution measuring device “Microtrac MT3300EX” (manufactured by Nikkiso Co., Ltd.).

The volume-average particle diameter (D50) of the magnetic carriers and the magnetic core particles was measured with a use of a sample supplying machine for dry measurement “one shot dry type sample conditioner Turbotrac” (manufactured by Nikkiso Co., Ltd.). Conditions for supply of Turbotrac were set so that the air flow rate was about 33 L/sec, and the pressure was about 17 kPa, while a dust collecting machine was used as a decompression source. Control is automatically performed on the software. The particle diameter is determined as a 50% particle diameter (D50) which is a cumulative value of the volume average. Control and analysis are performed with a use of an attached software (version 10.3.3-202D). The measurement conditions are as follows.
Set Zero time: 10 seconds
Measurement time: 10 seconds
Number of times of measurement: 1
Refractive index of particle: 1.81%
Particle shape: non-spherical
Upper limit of measurement: 1408 μm
Lower limit of measurement: 0.243 μm
Measurement environment: temperature of 23° C. and relative humidity of 50%

### <Method for Measuring Intensity of Magnetization of Magnetic Core Particle and Carrier>

The intensity of magnetization of the magnetic core particles and the carriers can be determined with a use of a vibrating magnetic field-type magnetic property measurement device (Vibrating sample magnetometer) or a direct current magnetization property recording device (B-H tracer). In Examples which will be described below, the intensity of magnetization is measured in the following procedure with a use of a vibrating magnetic field-type magnetic property measurement device BHV-30 (manufactured by Riken Denshi Co., Ltd.).

Magnetic core particles or carriers are sufficiently densely charged into a cylindrical plastic container, and are used as a sample. An actual mass of the sample filled in the container is measured. After that, the sample in the plastic container is adhered by an instant adhesive so that the sample does not move.

An external magnetic field axis and a magnetization moment axis are calibrated at 1000/4π (kA/m) with a use of a standard sample.

The intensity of magnetization was measured from a loop of magnetization moment obtained when an external magnetic field of 1000/4π (kA/m) was applied at a sweep rate of 5 (min/loop). The intensity of magnetization (Am²/kg) of the magnetic carriers and the magnetic core particles is determined by dividing the measured value by weight of the sample.

### <Measurement of Average Layer Thickness of Resin Coating Layer or Silicone Resin Layer>

The average layer thickness of the resin coating layer was measured by observing a cross section of the magnetic carrier with a transmission electron microscope (TEM) (each magnification of 50,000) and measuring the thickness of the resin coating layer.

Specifically, the magnetic carrier was subjected to ion milling with a use of an argon ion milling apparatus (trade name: E-3500, manufactured by Hitachi High-Technologies Corporation). The measurement conditions of ion milling are as follows.
Beam diameter: 400 μm (half-value width)
Acceleration voltage of ion gun: 5 kV
Discharge voltage of ion gun: 4 kV
Discharge current of ion gun: 463 μA
Irradiation current of ion gun: 90 μA/cm³/1 min

The thickness of the resin coating layer of the prepared cross section of the magnetic carrier was measured at arbitrary five points per particle, with a use of a scanning electron microscopic SU8220 (manufactured by Hitachi High-Technologies Corporation), and an arithmetic average thereof was defined as thickness of the resin coating layer of the carrier particle. In this case, the respective image regions showing the coating resin layer portion, the silicone resin portion and the magnetic body portion in a field of a view can be distinguished with a use of EDX observation in combination.

Measurement similar to the above was performed on 50 particles of the magnetic carrier, and the above operation was performed on 50 particles; and when the particles were arranged in an order of the thickness of the resin coating layer, the numerical values corresponding to first to tenth positions and numerical values corresponding to 41st to 50th positions were excluded, and an arithmetic average of the numerical values of the rest 30 points was defined as the thickness of the resin coating layer.

### <Measurement of Specific Resistance of Carrier>

The specific resistance is measured by a method of filling a cell with carriers, arranging a lower electrode and an upper electrode so as to come in contact with the carriers, applying a voltage between these electrodes, and measuring an electric current flowing when applying the voltage, and determining the specific resistance. Measurement conditions of the specific resistance were set so that a contact area S between the filled magnetic carriers and the electrode was about 2.4 cm², a sample thickness d was about 0.2 cm, and a load of the upper electrode was 240 g.

The voltage was applied in an order of the following application conditions (I), (II) and (III), and an electric current was measured by the applied voltage under the application condition (III). After that, the thickness d of the sample was accurately measured, and the specific resistance (Ω·cm) at each electric field intensity (V/cm) was determined by calculation, and the specific resistance at electric field intensity of 3000 V/cm was defined as the specific resistance of the magnetic carrier of the sample.

### Application Conditions

(I): (Changed from 0 V to 1000 V: increased in stepwise way by 200 V every 30 seconds)
(II): (held at 1000 V for 30 seconds)
(III): (Changed from 1000 V to 0 V: decreased in stepwise way by 200V every 30 seconds)

$$Specific resistance ( Ω \cdot cm ) of magnetic carrier = ( applied voltage ( V ) / measured current ( A ) ) \times S ( {cm}^{2} ) / d ( cm )$$

$$Electric field intensity ( V / cm ) = applied voltage ( V ) / d ( cm )$$

### <Measurement of Mass of Carrier or Temperature-Humidity Response of Silica Particle or Coating Resin>

The mass of the carrier or the temperature-humidity response of the silica particle or the coating resin was measured with a use of a thermogravimetric analysis device Q5000 (manufactured by TA Instruments). The measurement conditions are as follows.
Pan: Metallized Quartz
Gas1: Nitrogen
Gas2: Nitrogen
Balance Gas: Nitrogen 10.0 ml/min
Humidity Gas: Nitrogen 200.0 ml/min

As for a measurement sample, the following masses were measured as accurately as possible by weighing after a tare work of a pan. In addition, before the measurement, a device was calibrated.
Carrier: 25 mg
Silica particle: 5 mg
Coating resin: 25 mg

The measurement method was set as follows. Specifically, an operation was performed in which the sample was placed in an environment of 23° C. and 5% RH for 5 hours, then was left in an environment which was changed to 30° C. and 80% RH for 5 hours, and was left in the environment which was returned to 23° C. and 5% RH for 5 hours.
1: Equilibrate at 25.00° C.
2: Relative humidity 5.00%
3: Mark data
4: Isothermal for 300.00 min
5: Ramp 1.00° C./min to 30.00° C.
6: Ramp relative humidity 0.50%/min to 80.00%
7: Isothermal for 300.00 min
8: Ramp relative humidity 0.50%/min to 50.00%
9: Ramp 1.00° C./min to 23.00° C.
10: Ramp relative humidity 0.50%/min to 5.00%
11: Isothermal for 300.00 min

Among the masses recorded by the above measurement, an arithmetic average value of the masses which were recorded for 5 minutes from a time when 750 minutes had elapsed from a start of recording to a time when 755 minutes had elapsed was defined as mass of the carrier after having been held for 5 hours in the first environment of a temperature of 30° C. and a relative humidity of 80%; and the arithmetic average value of the masses recorded for 5 minutes when 1210 minutes had elapsed from the start of recording to a time when 1215 minutes had elapsed was used as a mass after the sample was held in the first environment and then held in the second environment of a temperature of 23° C. and a relative humidity of 5% for 5 hours.

### <Method for Measuring Exposure Ratio of Silica Particles on Surface of Carrier>

An exposure ratio of the silica particles on the surface of the carrier was measured by analyzing a secondary electron image obtained by a scanning electron microscope.

The secondary electron image was acquired with a use of a scanning electron microscope SU8220 (manufactured by Hitachi High-Technologies Corporation). Specifically, the carrier particles were fixed on a sample stage for electron microscope observation with a carbon tape so as to form a single layer, were subjected to a flushing operation, and then were observed. The observation conditions are as follows.

$$SignalName = SE ( U )$$

$$AcceleratingVoltage = 800 Volt$$

$$WorkingDistance = 8000 um$$

$$EmissionCurrent = 10000 nA$$

$$LensMode = High$$

$$Condencer 1 = 5000$$

$$ScanSpeed = slow 3$$

$$ColorMode = Grayscale$$

$$DataSize = 1280 \times 960$$

$$Magnification = 25000$$

In the measurement of the secondary electron image, contrast and brightness were set to 60 and −15, respectively, on a control software, and the image was acquired so that the resin layer as flat as possible was captured at central portion and contrast derived from a surface shape became as small as possible. In this case, respective image regions showing a resin layer portion and silica particle portion in a field of a view can be distinguished with a use of EDX observation in combination.

An exposure ratio of the silica particles on the surface of the carrier was calculated by an analysis of an obtained secondary electron image. Specifically, the image was subjected to the binarization processing that used “Python” which is a programming language, and “OpenCV” and “NumPy” which are extended libraries, and a number of pixels was calculated in each of which a luminance value was 255. The detailed procedure is as follows.

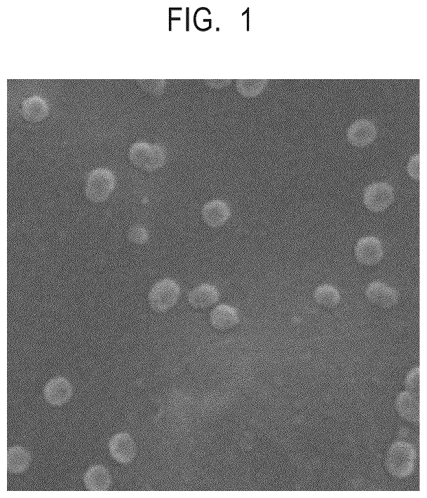

Firstly, a range of 400 pixels×400 pixels was trimmed from a part of the image. In this case, an image range was selected in which only a coating resin and silica particles were included, the image was as smooth as possible, and a contrast due to unevenness was small, by a visual inspection. One example of the image is shown in FIG. 1. Subsequently, median blur processing as shown in the Conditional Expression (1) was performed, and a noise was removed. In this regard, in Conditional Expression (1), “img” is a variable indicating an input image.

$$Cv 2. median Blur ( img , k size = 9 ) \qquad Conditional Expression ( 1 )$$

Furthermore, the image after the noise had been removed was binarized with the use of the Otsu's method so as to obtain an image including only pixels having a luminance value of 0 and pixels having a luminance value of 255. For this process, a condition shown in the Conditional Expression (2) was used. In this regard, in the Conditional Expression (2), “img” is a variable indicating an image after the median blur processing.

$$Cv 2. threshold ( img , 0 , 255 , cv 2. THRESH\_OTSU ) \qquad Conditional Expression ( 2 )$$

An exposure ratio of the silica particles on the surface of the carrier was calculated by calculating a number of pixels having the luminance value of 255 in a binarized image, and dividing a number of pixels by 160000 which was a number of pixels included in a range of 400 pixels×400 pixels. A condition used is shown in the Conditional Expression (3). In this regard, in the Conditional Expression (3), “img” is a variable indicating an image after the binarization process.

$$( img / 255 ) . sum ( ) / 160000 * 100 \qquad Conditional Expression ( 3 )$$

The above operation was performed on 50 particles; and when the 50 particles were arranged in order of an exposure ratio, numerical values corresponding to first to tenth places and numerical values corresponding to 41st to 50th places were excluded, and an arithmetic average of numerical values of rest 30 points was used as an exposure ratio of the silica particles on the surface of the carrier.

<Measurement of Coverage with Silicone Resin on Surface of Magnetic Core Particle>

The coverage with the silicone resin on the surface of the magnetic core particle was measured by analysis of a reflected electron image by a scanning electron microscope. In the scanning electron microscope observation, it is known that an amount of reflected electrons emitted from a sample is larger as the element is heavier. In a sample in which a resin portion and a metal oxide portion derived from the core exist, such as the surface of a magnetic core particle, the metal oxide portion appears bright and the resin portion appears dark, and accordingly an image is obtained which has a large contrast difference between the portions.

The reflected electron image was acquired with a use of a scanning electron microscopy SU8220 (manufactured by Hitachi High-Tech Corporation). Specifically, the carrier particles were fixed on a sample stage for electron microscope observation with a carbon tape so as to form a single layer, were subjected to a flushing operation, and then were observed. The observation conditions are as follows.

$$SignalName = LA 100 ( U )$$

$$AcceleratingVoltage = 10000 Volt$$

$$WorkingDistance = 8000 um$$

$$EmissionCurrent = 10000 nA$$

$$LensMode = High$$

$$Condencer 1 = 5000$$

$$ScanSpeed = slow 3$$

$$ColorMode = Grayscale$$

$$DataSize = 1280 ⨯ 960$$

$$Magnification = 2200$$

In the measurement of the secondary electron image, contrast and brightness were set to 60 and −15, respectively, on the control software, and the image was acquired so that central portion captured a center of the magnetic core particle. However, after the image was acquired, when a mass-converted abundance ratio of Si atoms measured by energy dispersive X-ray spectrometry which targeted a same visual field range and had acceleration voltage set to 20000 volt was 10% or smaller with respect to all detected elements, coverage with the silicone resin was set to 0 without performing quantification by the following image processing.

The coverage with the silicone resin on the surface of the magnetic core particle was calculated by analysis of an obtained reflected electron image. Specifically, the image was subjected to the binarization process that used “Python” which is a programming language, and “OpenCV” and “NumPy” which are extended libraries, and a number of pixels was calculated in each of which a luminance value was 255. One example of a detailed method will be described below.

Firstly, a range of 400 pixels×400 pixels was trimmed from a part of the image. In this case, the image range was selected so that a center of the magnetic core particle and a center of the image coincided with each other, by a visual observation. Subsequently, median blur processing as shown in the Conditional Expression (4) was performed, and a noise was removed. In this regard, in the Conditional Expression (4), “img” is a variable indicating an input image.

$$Cv 2. median Blur ( img , k size = 9 ) \qquad Conditional Expression ( 4 )$$

Furthermore, the image after the noise had been removed was binarized with a use of the Otsu's method so as to obtain an image including only pixels having a luminance value of 0 and pixels having a luminance value of 255. For this process, a condition shown in the Conditional Expression (5) was used. In this regard, in the Conditional Expression (5), “img” is a variable indicating an image after the median blur processing.

$$Cv 2. threshold ( img , 0 , 255 , cv 2. THRESH\_OTSU ) \qquad Conditional Expression ( 5 )$$

A coverage with the silicone resin on the surface of the magnetic core particle was calculated by calculating a number of pixels having a luminance value of 0 in the binarized image, and dividing a number of pixels by 160000 which was a number of pixels included in a range of 400 pixels×400 pixels. The condition used is shown in the Conditional Expression (6). In this regard, in the Conditional Expression (6), “img” is a variable indicating an image after the binarization process.

$$1 - ( img / 255 ) . sum ( ) / 160000 * 100 \qquad Conditional Expression ( 6 )$$

The above operation was performed on 50 particles; and when the particles were arranged in order of the coverage, numerical values corresponding to first to tenth places and numerical values corresponding to 41st to 50th places were excluded, and an arithmetic average of numerical values of rest 30 points was used as coverage with the silicone resin on the surface of the magnetic core particle.

### <Measurement of Coverage of Magnetic Body on Surface of Carrier>

The coverage of the magnetic body on the surface of the carrier was measured by analysis of a reflected electron image by a scanning electron microscope.

The reflected electron image was acquired with a use of a scanning electron microscopy SU8220 (manufactured by Hitachi High-Tech Corporation). Specifically, the carrier particles were fixed on a sample stage for electron microscope observation with a carbon tape so as to form a single layer, were subjected to a flushing operation, and then were observed. The observation conditions are as follows.

$$SignalName = LA 100 ( U )$$

$$AcceleratingVoltage = 10000 Volt$$

$$WorkingDistance = 8000 um$$

$$EmissionCurrent = 10000 nA$$

$$LensMode = High$$

$$Condencer 1 = 5000$$

$$ScanSpeed = slow 3$$

$$ColorMode = Grayscale$$

$$DataSize = 1280 ⨯ 960$$

$$Magnification = 2200$$

In the measurement of the secondary electron image, contrast and brightness were set on the control software, and the image was acquired under such conditions that a sufficient contrast could be obtained between the silica particles (silicone resin) on the surface of the carrier and the magnetic body portion.

An exposure ratio of the magnetic body on the surface of the carrier was calculated by an analysis of the obtained reflected electron image. Specifically, the image was subjected to the binarization process that used “Python” which is a programming language, and “OpenCV” and “NumPy” which are extended libraries, and a number of pixels was calculated in each of which a luminance value was 255. The detailed procedure is as follows.

Firstly, a range of 400 pixels×400 pixels was trimmed from a part of the image. In this case, the image range was selected so that a center of the carrier particle and a center of the image coincided with each other, by a visual observation. Subsequently, the median blur processing as shown in the Conditional Expression (7) was performed, and a noise was removed. In this regard, in the Conditional Expression (7), “img” is a variable indicating an input image.

$$Cv 2. median Blur ( img , k size = 9 ) \qquad Conditional Expression ( 7 )$$

Furthermore, the image after a noise had been removed was binarized with a use of the Otsu's method so as to obtain an image including only pixels having a luminance value of 0 and pixels having a luminance value of 255. For this process, the condition shown in Conditional Expression (8) was used. In this regard, in the Conditional Expression (8), “img” is a variable indicating an image after the median blur processing.

$$Cv 2. threshold ( img , 0 , 255 , cv 2. THRESH\_OTSU ) \qquad Conditional Expression ( 8 )$$

A coverage of the magnetic body on the surface of the carrier was calculated by calculating a number of pixels having the luminance value of 0 in the binarized image, and dividing a number of pixels by 160000 which was a number of pixels included in a range of 400 pixels×400 pixels. The condition used is shown in Conditional Expression (9). In this regard, in the Conditional Expression (9), “img” is a variable indicating an image after the binarization process.

$$1 - ( img / 255 ) . sum ( ) / 160000 * 100 \qquad Conditional Expression ( 9 )$$

The above operation was performed on 50 particles; and when the 50 particles were arranged in order of coverage of the magnetic body, numerical values corresponding to first to tenth places and numerical values corresponding to 41st to 50th places were excluded, and an arithmetic average of numerical values of rest 30 points was used as the coverage of the magnetic body on the surface of the carrier.

### <Measurement of Element Ratio of Surface of Magnetic Core Particle>

An element ratio of the surface of the magnetic core particle was measured by XPS measurement. In the measurement, the magnetic carrier was attached to an indium foil. In this case, the particles were uniformly attached so that the indium foil portion was not exposed.

A PHI 5000 VERSAPROBE II (manufactured by ULVAC-PHI, Inc.) was used for a measurement, and the measurement conditions were set in the following way.

As a preliminary measurement for selecting an element of which the XPS peak is to be observed, a survey measurement was performed in advance under same conditions, and subsequently, all elements to be detected in a main measurement were analyzed.
Irradiation ray: AlKα ray
Output: 25 W and 15 kV
Photoelectron take-in angle: 450
Pass Energy: 58.7 eV
Step size: 0.125 eV

Five or more points were measured for each sample, and an arithmetic average of the measured values was used as the measured value.

### <Method for Measuring Volume-Average Particle Diameter of Silica Particles>

A solution was prepared in which 0.2 g of 5% triton solution and 19.8 g of RO water were added to 10 mg of dried silica particles. Next, a tip of a probe of an ultrasonic disperser was immersed in the above solution, and dispersed the content by an ultrasonic wave for 15 minutes by an output power of 20 W; and thereby, a dispersion liquid was obtained. Subsequently, volume-average particle diameter of the dispersion liquid was measured with a use of a dynamic light scattering type (DLS) particle diameter distribution measuring device (trade name: Nanotrac 150, manufactured by MicrotracBEL Corp.).
Mode: transmission
Particle condition: spherical
Refractive index of particle: 1.45
Particle density: 1.30
Refractive index of dispersion medium: 1.33 (water)
Measurement time: 120 seconds

### <Measurement of Density of Silanol Groups on Surface of Silica Particle>

Density of silanol groups on the surface of the silica particle (number of silanol groups present on surface of silica particle, per unit surface area of silica particle) was calculated by a lithium aluminum hydride (LAH) method. Specifically, the silica particles after vacuum drying were dispersed in dehydrated dimethyl ether, a sufficient amount of LAH dimethyl ether solution was added dropwise, and the mixture was sufficiently stirred until hydrogen was not generated. An amount of generated hydrogen was measured by gas chromatography.

The density of silanol groups per unit surface area was calculated by dividing a number of silanol groups calculated from the amount of generated hydrogen, by the specific surface area which was measured with the use of an “Automatic Specific Surface Area and Pore Distribution Analyzer TriStar 3000 (Shimadzu Corporation)” which employed a gas adsorption method according to constant volume method as measurement method.

For information, setting of measurement conditions of specific surface area and analysis of the measurement data are performed with a use of a dedicated software “TriStar 3000 Version 4.00” which is provided in a device. In addition, a vacuum pump, a nitrogen gas pipe, and a helium gas pipe are connected to the device. Nitrogen gas was used as an adsorption gas, and a value calculated by a BET multipoint method was defined as a BET specific surface area.

### <Method for Measuring Work Function of Silica Particle or Silica Particle External Additive>

The work function was measured with a use of a surface analysis device (AC-2, manufactured by Riken Keiki Co., Ltd., and low energy electron counting system). In the device, a deuterium lamp was used, an amount of irradiating light was set to 500 nW, a monochromatic ray was selected by a spectroscope, and a spot size was set to 4 mm angle. A sample was irradiated with the light under such conditions that an energy scanning range was 3.40 to 6.20 eV, an interval was 0.05 eV, measuring time was 10 sec/1 point, and photoelectrons emitted from the sample surface were detected. Work function was determined to be measured at a repeatability (standard deviation) of 0.02 eV.

In this measurement, when excitation energy of monochromatic light was scanned from a lower value to a higher value, photon emission started from a certain energy value (eV), and this energy value was defined as a work function (eV). When the excitation energy (eV) is taken on the horizontal axis and the normalized photon yield (n-th power of yield of photoelectron per unit photon) is taken on a vertical axis, a constant slope (Y/eV) is obtained, and work function is represented by an excitation energy value (eV) at an inflection point (A). One specific example of a method of obtaining the inflection point (A) will be shown below.

Regression curve: the regression curve was obtained by selecting first to fourth points where normalized photon yield continuously increased at four or more points between 3.40 eV and 6.20 eV of excitation energy of the irradiating light.

Ground line: points selected from excitation energy of 3.40 eV of the irradiating light up to a point not including a supporting point were taken as grand line. The excitation energy value at an intersection of the ground line and the regression curve was taken as work function. In order to ensure repeatability of data, the samples to be measured were left to stand for 24 hours under conditions of a temperature of 23° C. and a humidity of 50 RH %.

### EXAMPLES

Effects of the present disclosure will be described below with reference to Examples. Materials, additives, amounts and concentrations of use, treatment methods and procedures shown in the following Examples can be appropriately modified without departing from gist of the present disclosure, and the embodiments of the present disclosure should not be construed as being limited by the contents of the Examples.

In the following description, “%” and “part (s)” are based on mass unless otherwise specified.

### <Production Example of Toner>

### <Production Example of Resin A>

Polyoxypropylene (2.2)-2,2-bis(4-hydroxyphenyl) propane: 76.3 parts
Terephthalic acid: 16.1 parts
Succinic acid: 7.6 parts
Titanium tetrabutoxide (esterification catalyst): 0.5 parts

The above materials were weighed into a reaction vessel equipped with a cooling tube, a stirrer, a nitrogen introduction tube, and a thermocouple.

Next, an inside of a flask was replaced with nitrogen gas, then, the temperature was gradually raised while stirring, and the mixture was reacted for 4 hours while having been stirred at a temperature of 200° C.

Furthermore, pressure in the reaction vessel was lowered to 8.3 kPa, was maintained for 1 hour, was cooled to 160° C., and returned to atmosphere pressure (first reaction step).
tert-Butylcatechol (polymerization inhibitor): 0.1 parts

After that, the above material was added, the pressure in the reaction vessel was lowered to 8.3 kPa, the mixture was reacted for 1 hour while maintaining temperature at 180° C., softening point measured according to ASTM D36-86 was confirmed to have reached a temperature of 90° C., then, the temperature was lowered, and the reaction was stopped (second reaction step); and resin A was obtained. The obtained resin A had a peak molecular weight Mp of 4500, a softening point Tm of 90° C., and a glass-transition temperature Tg of 54° C.

### <Production Example of Resin B>

Polyoxypropylene (2.2)-2,2-bis(4-hydroxyphenyl) propane: 74.8 parts
Terephthalic acid: 12.9 parts
Adipic acid: 7.9 parts
Titanium tetrabutoxide (esterification catalyst): 0.5 parts

The above materials were weighed into a reaction vessel equipped with a cooling tube, a stirrer, a nitrogen introduction tube, and a thermocouple.

Next, an inside of a flask was replaced with nitrogen gas, then, temperature was gradually raised while stirring, and the mixture was reacted for 2 hours while having been stirred at a temperature of 200° C.

Furthermore, the pressure in the reaction vessel was lowered to 8.3 kPa, was maintained for 1 hour, was cooled to 160° C., and returned to atmosphere pressure (first reaction step).
Trimellitic Acid: 5.9 parts
tert-Butylcatechol (polymerization inhibitor): 0.1 parts

After that, the above materials were added, the pressure in the reaction vessel was lowered to 8.3 kPa, the mixture was submitted to a reaction for 15 hours while maintaining temperature at 200° C., the softening point measured according to ASTM D36-86 was confirmed to have reached a temperature of 140° C., then, the temperature was lowered, and the reaction was stopped (second reaction step); and resin B was obtained. The obtained resin B had a peak molecular weight Mp of 10000, a softening point Tm of 140° C., and a glass-transition temperature Tg of 60° C.

### <Production Example of Resin C>

Hexanediol: 33.9 parts
Dodecanedioic acid: 66.1 parts

The above materials were weighed into a reaction vessel equipped with a cooling tube, a stirrer, a nitrogen introduction tube, and a thermocouple. Next, an inside of a flask was replaced with nitrogen gas, then, temperature was gradually raised while stirring, and the mixture was reacted for 3 hours while having been stirred at a temperature of 140° C.
Tin 2-ethylhexanoate: 0.5 parts

After that, the above material was added, the pressure in the reaction vessel was lowered to 8.3 kPa, the mixture was reacted for 4 hours while the temperature was maintained at 200° C., and resin C was obtained (first reaction step). The obtained resin C had a weight-average molecular weight Mw of 11000, and a melting peak temperature Tp of 72° C.

### <Production Example of Dispersing Agent D>

Low molecular weight polypropylene (Viscol 660P manufactured by Sanyo Chemical Industries, Ltd.): 10.0 parts
Xylene: 25.0 parts

The above materials were weighed into a reaction vessel equipped with a cooling tube, a stirrer, a nitrogen introduction tube, and a thermocouple. Next, an inside of a flask was replaced with nitrogen gas, and then, temperature was gradually raised to 175° C. while stirring.
Styrene: 65.0 parts
Cyclohexyl acrylate: 5.5 parts
Butyl acrylate: 12.5 parts
Methacrylic acid: 5.5 parts
Xylene: 10.0 parts
Di-t-butyl peroxyhexahydroterephthalate: 0.5 parts

After that, the above materials were added dropwise over 3 hours, and the mixture was further stirred for 30 minutes. Then, the solvent was distilled off, and a dispersing agent D was obtained in which a styrene-acrylic polymer was graft-polymerized to the polyolefin. The dispersing agent D had a peak molecular weight Mp of 6000 and a softening point of 125° C.

### <Production Example of Toner>

| | | |
|---|---|---|
| Resin A | 62 | parts |
| Resin B | 28 | parts |
| Resin C | 10 | parts |
| Dispersing agent D | 4 | parts |
| Fischer-Tropsch wax (peak temperature of maximum | 4 | parts |
| endothermic peak: 90° C.) | | |
| C.I. Pigment Blue 15:3 | 7 | parts |

The above materials were mixed with a use of a Henschel mixer (FM-75 type, manufactured by Mitsui Mining Co., Ltd.) at a rotation number of 20 s⁻¹ and for a rotation time of 5 min, and then were kneaded with a twin-screw kneading machine (PCM-30 type, manufactured by Ikegai Corp.) set at a temperature of 130° C. The obtained kneaded product was cooled and coarsely pulverized to 1 mm or smaller with a hammermill, and a coarsely pulverized product was obtained. The obtained coarsely pulverized product was finely pulverized with a mechanical pulverizing machine (T-250, manufactured by Freund-Turbo Corporation). The resultant was classified with the use of Faculty F-300 (manufactured by Hosokawa Micron Corporation), and a toner particle was obtained. The operation conditions were set in such a way that a rotation number of a classification rotor was 130 s⁻¹, and a rotation number of a dispersion rotor was 120 s⁻¹.

The obtained toner particles were used and subjected to heat treatment by a surface treatment apparatus shown in FIG. 2, and heat-treated toner particles were obtained. The operation conditions were set in such a way that a feed rate was 5 kg/hr, a hot air temperature was 160° C., a hot air flow was 6 m³/min, a cold air temperature was −5° C., a cold air flow was 4 m³/min, a blower air flow was 20 m³/min, and an injection air flow was 1 m³/min.

A toner was obtained by mixing 100 parts of the obtained heat-treated toner particles with 1.0 part of hydrophobic silica particles (BET: 200 m²/g) and 1.0 part of titanium oxide fine particles (BET: 80 m²/g) which were surface-treated with isobutyl trimethoxy silane, by a Henschel mixer (FM-75 type, manufactured by Mitsui Miike Chemical Engineering Machinery Co., Ltd.) at a rotation number of 30 s⁻¹ and for a rotation time of 10 min. Volume-average particle diameter (D4) of the toner was measured with “CDA-1000X” (aperture size: 100 μm, manufactured by Sysmex Corporation), and as a result, was 6.3 μm. Average circularity of the toner was measured with a flow particle image analysis device “FPIA-3000” (manufactured by Sysmex Corporation), and as a result, was 0.967.

### <Production Example of Magnetic Core Particle>

### <Production Example of Magnetic Particle 1>

Step 1 (Weighing and mixing step)

| | |
|---|---|
| Fe₂O₃ | 68.3% |
| MnCO₃ | 28.5% |
| Mg(OH)₂ | 2.0% |
| SrCO₃ | 1.2% |

Ferrite raw materials were weighed so that the above composition was satisfied.

After that, 20 parts of distilled water was added to 80 parts of the above mixture of ferrite materials, and the resultant was pulverized and mixed for 3 hours with a ball mill which used zirconia balls (10 mm ϕ), and a slurry was obtained.

### Step 2 (Pre-Calcining Step)

The slurry was dried with a spray dryer (manufactured by Ohkawara Kakohki Co., Ltd.) and was calcined in a batch-type electric furnace in a nitrogen atmosphere (oxygen concentration: 1.0% by volume) at a temperature of 1050° C. for 3.0 hours, and a pre-calcined ferrite was produced.

### Step 3 (Pulverization Step)

The pre-calcined ferrite was pulverized to about 0.5 mm with a crasher, and then, was pulverized for 3 hours with a wet bead mill which used stainless steel beads having a diameter of ⅛ inches, and a slurry was obtained. The slurry was further pulverized for 4 hours by a wet-type ball mill which used zirconia balls (1.0 mm ϕ), and a slurry of pre-calcined ferrite was obtained.

### Step 4 (Granulation Step)

To 100 parts by mass of the slurry of pre-calcined ferrite, 1.0 part by mass of ammonium polycarboxylate and 1.5 parts of polyvinyl alcohol were added, and the mixture was granulated into spherical particles of 37 μm by a spray dryer (manufactured by Ohkawara Kakohki Co., Ltd.). The obtained granulated product was heated at 700° C. for 2 hours with a use of a rotary-type electric furnace.

### Step 5 (Main Calcination Step)

The granulated product was held in a nitrogen atmosphere (oxygen concentration: 1.0% by volume) at 1100° C. for 4 hours in which a period from room temperature to the calcination temperature (1100° C.) was set to 2 hours, and was calcined. After that, the temperature was lowered to 60° C. over 8 hours, the nitrogen atmosphere was returned to the air, and the resultant product was taken out at a temperature of 40° C. or lower.

### Step 6 (Sorting Step)

The aggregated particles were crushed, and coarse particles were removed by sieving with a sieve having an opening of 150 μm, and fine powder was removed by air classification. Furthermore, a low magnetic force component was removed by magnetic separation, and a magnetic particle 1 was obtained. A shape of the magnetic particle 1 was observed with a use of a scanning electron microscope SU8220 (manufactured by Hitachi High-Tech Corporation), and as a result, was observed to be porous and have pores.

### <Production Example of Magnetic Particle 2>

Step 1 (Weighing and mixing step)

| | |
|---|---|
| Fe₂O₃ | 61.7% |
| MnCO₃ | 34.2% |
| Mg(OH)₂ | 3.0% |
| SrCO₃ | 1.1% |

The ferrite raw materials were weighed so that the above composition was satisfied.

After that, 20 parts of distilled water was added to 80 parts of the above mixture of ferrite materials, and the resultant was pulverized and mixed for 3 hours with a ball mill which used zirconia balls (10 mm ϕ), and a slurry was obtained.

### Step 2 (Pre-Calcining Step)

The slurry was dried with a spray dryer (manufactured by Ohkawara Kakohki Co., Ltd.) and was calcined in a batch-type electric furnace in a nitrogen atmosphere (oxygen concentration: 1.0% by volume) at a temperature of 1050° C. for 3.0 hours, and a pre-calcined ferrite was produced.

### Step 3 (Pulverization Step)

The pre-calcined ferrite was pulverized to about 0.5 mm with a crasher, and then, was pulverized for 3 hours with a wet bead mill which used stainless steel beads having a diameter of ⅛ inches, and a slurry was obtained. The slurry was further pulverized for 4 hours by a wet-type ball mill which used zirconia balls (1.0 mm ϕ), and a slurry of pre-calcined ferrite was obtained.

### Step 4 (Granulation Step)

To 100 parts by mass of the slurry of pre-calcined ferrite, 1.0 part by mass of ammonium polycarboxylate and 1.5 parts of polyvinyl alcohol were added, and the mixture was granulated into spherical particles of 37 μm by a spray dryer (manufactured by Ohkawara Kakohki Co., Ltd.). The obtained granulated product was heated at 700° C. for 2 hours with the use of a rotary-type electric furnace.

### Step 5 (Main Calcination Step)

In order to control a calcination atmosphere, the resultant product was calcined at 1200° C. for 6 hours in a nitrogen atmosphere (oxygen concentration: 0.6% by volume) in an electric furnace.

### Step 6 (Sorting Step)

The aggregated particles were crushed, and coarse particles were removed by sieving with a sieve having an opening of 150 μm, and fine powder was removed by air classification. Furthermore, a low magnetic force component was removed by magnetic separation, and a magnetic particle 2 was obtained. A surface shape of the magnetic particle 2 was observed with a use of a scanning electron microscope SU8220 (manufactured by Hitachi High-Tech Corporation), and as a result, a particle having a pore on the surface of the magnetic body was not observed.

### <Production Example of Magnetic Core Particle>

### <Production Example of Magnetic Core Particle 1>

Into a stirring container with a mixing stirrer (universal stirrer NDMV type manufactured by Dalton Corporation), 100.0 parts of the magnetic particles 1 were charged, and while temperature was maintained at 60° C., and while pressure was reduced to the 2.3 kPa, nitrogen gas was introduced; and a silicone resin solution (product name of SR2410, manufactured by Toray Dow Corning, solution in which to toluene solution containing 10% solid content, 1% titanium n-butoxide with respect to the solid content was added) was added dropwise under a reduced pressure so that a resin component became 7.5 parts, and the mixture was continued to be stirred for 2 hours after completion of dropwise addition.

After that, the temperature was raised to 70° C., the solvent was removed under reduced pressure, a silicone resin composition which was obtained from the silicone resin solution was distributed in an inside of the particles and on a surface of the magnetic particles 1. The obtained magnetic core particles were cooled, and then, were transferred to a mixer (UD-AT type drum mixer manufactured by Sugiyama Heavy Industrial, Co., Ltd.) having a spiral blade in a rotatable mixing container, and the temperature was raised to 220° C. at a temperature rising rate of 2 (° C./min), under a nitrogen atmosphere and a normal pressure. The magnetic core particles were heated and stirred at the temperature for 60 minutes, and the resin was cured. The resultant particles were heat-treated, then, a low magnetic force product was separated by magnetic separation, and the resultant was classified with a sieve having an opening of 150 μm; and a magnetic core particle 1 was obtained.

### <Production Example of Magnetic Core Particle 2>

A magnetic core particle 2 was obtained in a same way as in the magnetic core particle 1, except that the magnetic particle to be used was changed to the magnetic particle 2 and the amount of the silicone resin solution to be added dropwise was set to 0.5 parts as the resin component.

### <Production Example of Magnetic Core Particle 3>

A magnetic core particle 3 was obtained in the same way as in the magnetic core particle 1, except that the amount of the silicone resin solution to be added dropwise was set to 7.2 parts as the resin component.

### <Production Example of Magnetic Core Particle 4>

A magnetic core particle 4 was obtained in the same way as in the magnetic core particle 1, except that the amount of the silicone resin solution to be added dropwise was set to 6.8 parts as the resin component.

### <Production Example of Magnetic Core Particle 5>

A magnetic core particle 5 was obtained in the same way as in the magnetic core particle 1, except that the amount of the silicone resin solution to be added dropwise was set to 6.3 parts as the resin component.

### <Production Example of Magnetic Core Particle 6>

Magnetite fine particles (spherical shape, number-average particle diameter of 250 nm) and a silane-based coupling agent (3-(2-aminoethylaminopropyl) trimethoxy silane) (in an amount of 3.0% with respect to the magnetite fine particles) were introduced into a container. Then, the magnetite fine particles were mixed and stirred at a high speed at a temperature of 100° C. or higher in the container, and the magnetite fine particles were surface-treated.

| | |
|---|---|
| Phenol | 10 parts |
| Formaldehyde solution (37% by mass aqueous solution of | 16 parts |
| formaldehyde) | |
| The above surface-treated magnetite fine particle | 84 parts |

The above materials were introduced into a reaction kettle, and mixed well at a temperature of 40° C.

After that, the mixture was heated to a temperature of 85° C. at an average temperature rising rate of 3 (° C./min) while being stirred, and 4 parts of 28% ammonia water and 25 parts of water were added to the reaction kettle. The temperature was held at 85° C., and polymerization reaction was continued for 3 hours to achieve curing. A peripheral speed of the stirring blade was set to 1.8 (m/sec).

After the polymerization reaction has completed, the magnetite fine particles were cooled to a temperature of 30° C., and water was added thereto. A supernatant was removed and an obtained precipitate was washed with water and further was air-dried. The obtained air-dried product was dried at a temperature of 60° C. under a reduced pressure (5 hPa or lower), and a magnetic body-dispersed type of magnetic core particle 6 was obtained.

### <Preparation of Magnetic Core Particle 7>

The produced magnetic particle 2 was used as a magnetic core particle 7.

The physical properties of the produced magnetic core particles are shown in Table 1.

TABLE 1

| | Coverage with | | | |
|---|---|---|---|---|
| Magnetic core | silicone | M_atm | Si_atm | M_atm/ |
| particle No. | resin (area %) | (atomic %) | (atomic %) | Si_atm |
| 1 | 78.2 | 3.63 | 18.56 | 0.196 |
| 2 | 77.6 | 3.77 | 18.22 | 0.207 |
| 3 | 68.2 | 4.77 | 16.42 | 0.290 |
| 4 | 60.9 | 5.94 | 14.75 | 0.403 |
| 5 | 57.3 | 6.23 | 13.84 | 0.450 |
| 6 | 20.3 | 6.10 | 1.35 | 4.519 |
| 7 | 0 | 43.6 | 2.01 | 21.692 |

### <Production Example of Silica Particle>

### <Production Example of Silica Particle 1>

To a reaction container which is made from glass and is equipped with a stirrer and two channels of dripping device, 100 parts of methanol and 16 parts of 15% aqueous ammonia solution were added, and the obtained mixture was stirred at 35° C. under a nitrogen stream. A rotation speed of the stirrer was adjusted to 150 rpm, and tetramethoxy silane and 5.4% aqueous ammonia solution were added dropwise at a same time. A dripping device was set so that the dripping speeds each became 31.1 parts per hour and 13.4 parts per hour. Tetramethoxy silane was added dropwise for 6 hours, and a 5.4% aqueous ammonia solution was added dropwise for 5 hours; and then, the mixture was stirred for 10 minutes in a state in which the temperature was maintained.

The solvent of the obtained mixture was distilled off under reduced pressure, and the obtained solid was sufficiently dried, and heated in an oven at 400° C. for 10 minutes.

Into an autoclave, 100 parts of the obtained solid was charged, and an inside of an autoclave was replaced with nitrogen. While the contents in the autoclave were stirred, 0.7 parts of hexamethyl disilazane and 0.2 parts of distilled water were uniformly sprayed, which were atomized by a two-fluid nozzle. The autoclave was sealed, and the resultant mixture was stirred for 30 minutes, and then was heated at 200° C. for 2 hours. After that, the inside was depressurized while being heated, and thus a silica particle 1 was obtained.

### <Production Example of Silica Particle 2>

A silica particle 2 was obtained in a same way as in the silica particle 1, except that the amount of methanol to be charged was changed to 120 parts.

### <Production Example of Silica Particle 3>

A silica particle 3 was obtained in the same way as in the silica particle 1, except that the amount of methanol to be charged was changed to 70 parts.

### <Production Example of Silica Particle 4>

A silica particle 4 was obtained in the same way as in the silica particle 1, except that the amount of methanol to be charged was changed to 150 parts.

### <Production Example of Silica Particle 5>

A silica particle 5 was obtained in the same way as in the silica particle 1, except that the amount of methanol to be charged was changed to 55 parts.

### <Production Example of Silica Particle 6>

A silica particle 6 was obtained in the same way as in the silica particle 1, except that the amount of hexamethyl disilazane sprayed by the two-fluid nozzle was changed to 0.2 parts and the amount of distilled water was changed to 0.5 parts.

### <Production Example of Silica Particle 7>

A silica particle 7 was obtained in the same way as in the silica particle 1, except that the amount of hexamethyl disilazane sprayed by the two-fluid nozzle was changed to 0.1 parts and the amount of distilled water was changed to 0.5 parts.

### <Production Example of Silica Particle 8>

A silica particle 8 was obtained in the same way as in the silica particle 1, except that the amount of methanol to be charged is changed to 75 parts, the amount of hexamethyl disilazane sprayed by the two-fluid nozzle was changed to 1.2 parts and the amount of distilled water was changed to 0.5 parts.

### <Production Example of Silica Particle 9>

A silica particle 9 was obtained in the same way as in the silica particle 1, except that the amount of methanol to be charged is changed to 70 parts, the amount of hexamethyl disilazane sprayed by the two-fluid nozzle was changed to 1.2 parts and the amount of distilled water was changed to 0.5 parts.

### <Preparation of Silica Particle 10>

A commercially available fumed silica particle of which the surface was treated with hexamethyl disilazane was prepared, and was used as a silica particle 10.

### <Production Example of Silica Particle 11>

A silica particle 11 was obtained in the same way as in the silica particle 1, except that the amount of hexamethyl disilazane sprayed by the two-fluid nozzle was changed to 2.5 parts and the amount of distilled water was changed to 0.3 parts.

### <Production Example of Silica Particle 12>

A silica particle 12 was obtained in the same way as in the silica particle 1, except that the amount of hexamethyl disilazane sprayed by the two-fluid nozzle was changed to 0.05 parts and the amount of distilled water was changed to 0.7 parts.

### <Production Example of Silica Particle 13>

A silica particle 13 was obtained in the same way as in the silica particle 1, except that the amount of hexamethyl disilazane sprayed by the two-fluid nozzle was changed to 0.02 parts and the amount of distilled water was changed to 0.7 parts.

Physical properties of the produced silica particles are shown in Table 2.

TABLE 2

| Silica | | | (M3 − | Volume-average | Number of silanol |
|---|---|---|---|---|---|
| particle | M3 | M4 | M4)/M3 × | particle | groups per unit |
| No. | (mg) | (mg) | 100 | diameter (nm) | area (pieces/nm²) |
| 1 | 5.112 | 4.863 | 4.871 | 100 | 1.76 |
| 2 | 5.023 | 4.765 | 5.136 | 50 | 1.78 |
| 3 | 5.086 | 4.867 | 4.306 | 220 | 1.70 |
| 4 | 4.998 | 4.726 | 5.442 | 20 | 1.79 |
| 5 | 5.002 | 4.796 | 4.118 | 300 | 1.68 |
| 6 | 5.064 | 4.801 | 5.194 | 100 | 1.95 |
| 7 | 5.128 | 4.843 | 5.558 | 100 | 2.08 |
| 8 | 5.038 | 4.876 | 3.216 | 190 | 1.62 |
| 9 | 4.992 | 4.85 | 2.845 | 220 | 1.53 |
| 10 | 5.024 | 5.018 | 0.119 | 100 | 1.77 |
| 11 | 5.052 | 4.838 | 4.236 | 100 | 1.24 |
| 12 | 5.061 | 4.598 | 9.148 | 100 | 2.13 |
| 13 | 4.99 | 4.449 | 10.842 | 100 | 2.33 |

<Production Example of Coating Resin><Production example of coating resin solution 1>

Eighty parts of cyclohexyl methacrylate and twenty parts of methyl methacrylate were added to a four neck flask having a reflux condenser, a thermometer, a nitrogen suction tube, and a ground-joint type stirring device.

Furthermore, 100 parts of toluene, 100 parts of methyl ethyl ketone, and 2.0 parts of azobisisovaleronitrile were added thereto. The obtained mixture was held at 70° C. for 10 hours under a nitrogen stream, after the polymerization reaction was completed, washing was repeated, and a coating resin solution 1 (solid content: 35%) was obtained.

### <Production Example of Coating Resin Solution 2>

A coating resin solution 2 was obtained in a same way as in the coating solution 1, except that 60 parts of cyclohexyl methacrylate and 40 parts of methyl methacrylate were used in place of 80 parts of cyclohexyl methacrylate and 20 parts of methyl methacrylate.

### <Production Example of Coating Resin Solution 3>

A coating resin solution 3 was obtained in the same way as in the coating solution 1, except that 40 parts of cyclohexyl methacrylate and 60 parts of methyl methacrylate were used in place of 80 parts of cyclohexyl methacrylate and 20 parts of methyl methacrylate.

### <Production Example of Coating Resin Solution 4>

A coating resin solution 4 was obtained in the same way as in the coating resin solution 1, except that 100 parts of methyl methacrylate was used in place of 80 parts of cyclohexyl methacrylate and 20 parts of methyl methacrylate.

### <Preparation of Coating Resin Solution 5>

Methyl ethyl ketone was added to KR271 manufactured by Shin-Etsu Chemical Co., Ltd.; and the mixture was adjusted so that the solid content became 35%, and was used as a coating resin solution 5.

### <Production of Resin Coating Liquid 1>

Toluene and methyl ethyl ketone were added at a ratio of 1:1 to 100 parts of the coating resin solution 1 serving as a resin solid content so that the solid content ratio became 5%. Furthermore, 25 parts of the silica particles 1 were added, and the obtained mixture was shaken and stirred for 15 minutes with the use of a paint shaker (manufactured by Radia Inc.), and a resin coating liquid 1 was obtained.

### <Method for Producing Resin Coating Liquids 2 to 23>

Resin coating liquids 2 to 23 were obtained in a same way as in the resin coating liquid 1, except that the type of the coating resin solution and the type and the amount to be charged of the silica particles were changed as shown in Table 3.

TABLE 3

| | | | Amount of silica |
|---|---|---|---|
| Resin coating | Coating resin | Silica | particles (parts |
| liquid No. | solution No. | particle No. | by mass) |
| 1 | 1 | 1 | 25 |
| 2 | 1 | 1 | 25 |
| 3 | 2 | 1 | 25 |
| 4 | 1 | 2 | 25 |
| 5 | 1 | 3 | 25 |
| 6 | 1 | 4 | 25 |
| 7 | 1 | 5 | 25 |
| 8 | 1 | 6 | 25 |
| 9 | 1 | 7 | 25 |
| 10 | 3 | 1 | 25 |
| 11 | 4 | 1 | 25 |
| 12 | 1 | 8 | 25 |
| 13 | 1 | 9 | 25 |
| 14 | 1 | 1 | 35 |
| 15 | 1 | 1 | 50 |
| 16 | 1 | 1 | 20 |
| 17 | 1 | 1 | 10 |
| 18 | 1 | 10 | 25 |
| 19 | 5 | 1 | 25 |
| 20 | 1 | N/A | — |
| 21 | 1 | 11 | 25 |
| 22 | 1 | 12 | 25 |
| 23 | 1 | 13 | 25 |

### <Production Example of Magnetic Carrier>

### <Production Example of Magnetic Carrier 1>

| | |
|---|---|
| Magnetic core particle 1 | 100 parts |
| Resin coating liquid 1 | 40 parts |

The above materials were charged into a planetary motion type mixer (Nauta Mixer VN type manufactured by Hosokawa Micron Corporation) which was maintained at a temperature of 60° C. under a reduced pressure (1.5 kPa). As for a method of charging, firstly, a whole amount of the magnetic core particles was charged, then, ⅓ of an amount of the resin coating liquid was charged, and an operation of solvent removal and coating was performed for 20 minutes. Next, another ⅓ of the amount of the resin coating liquid was charged, and an operation of solvent removal and coating was performed for 20 minutes; and further another ⅓ of the amount of the resin coating liquid was charged, and the operation of solvent removal and coating was performed for 20 minutes.

After that, the magnetic carrier which was coated with the coating resin composition was transferred to a mixer (UD-AT type drum mixer manufactured by Sugiyama Heavy Industrial, Co., Ltd.) having a spiral blade in a rotatable mixing container. The magnetic carrier was subjected to heat treatment at a temperature of 120° C. for 2 hours in a nitrogen atmosphere, while the mixing container was rotated at 10 rotations per minute and the magnetic carrier was stirred. The obtained magnetic carrier 1 was subjected to magnetic separation, thereby a low magnetic force product was separated, and the resultant was passed through a sieve having an opening of 150 μm, and then was classified with an air classifier; and a magnetic carrier 1 was obtained.

### <Production Example of Magnetic Carriers 2 to 24>

Magnetic carriers 2 to 24 were obtained in a same way as in the magnetic carrier 1, except that the types and the quantities of the magnetic core particles and the resin coating liquids to be charged were changed as shown in Table 4.

### <Production Example of Magnetic Carrier 25>

| | |
|---|---|
| Magnetic core particle 1 | 100 parts |
| Resin coating liquid 19 | 40 parts |

The above materials were charged into a planetary motion type mixer (Nauta Mixer VN type manufactured by Hosokawa Micron Corporation) which was maintained at a temperature of 40° C. under a reduced pressure (1.5 kPa). As for the method of charging, firstly, a whole amount of the magnetic core particles was charged, then, ⅓ of an amount of the resin coating liquid was charged, and an operation of solvent removal and coating was performed for 20 minutes. Next, another ⅓ of the amount of the resin coating liquid was charged, and the operation of solvent removal and coating was performed for 20 minutes; and further another ⅓ of the amount of the resin coating liquid was charged, and the operation of solvent removal and coating was performed for 20 minutes.

After that, the content was transferred to a mixer (UD-AT type drum mixer manufactured by Sugiyama Heavy Industrial, Co., Ltd.) having a spiral blade in a mixing container. The content was subjected to heat treatment in a nitrogen atmosphere at a temperature of 200° C. for 2 hours, while the mixing container was rotated at 10 rotations per minute and the content was stirred; and thereby, a magnetic carrier 25 was obtained.

### <Production Example of Magnetic Carriers 26 to 30>

Magnetic carriers 26 to 30 were obtained in the same way as in the magnetic carrier 1, except that the types and the quantities of the magnetic core particles and the resin coating liquids to be charged were changed as shown in Table 4.

The physical properties and the composition of the produced magnetic carriers are shown in Table 4.

TABLE 4

| | | | Amount | | | | | | | | |
|---|---|---|---|---|---|---|---|---|---|---|---|
| | | | of resin | | | | | | | | |
| | | | coating | Exposure | Coverage | | | | | | |
| | Magnetic | Resin | liquid | ratio of | of | | | | | | |
| Magnetic | core | coating | (parts | silica | magnetic | | | | | | |
| carrier | particle | liquid | by | particles | body | M1 | M2 | (M1 − M2)/ | M5 | M6 | (M5 − M6)/ |
| No. | No. | No. | mass) | (area %) | (area %) | (mg) | (mg) | M1 × 100 | (mg) | (mg) | M5 × 100 |
| 1 | 1 | 1 | 40 | 14.8 | 91.5 | 25.013 | 24.994 | 0.076 | 25.068 | 24.960 | 0.431 |
| 2 | 2 | 2 | 40 | 14.7 | 91.0 | 25.014 | 24.997 | 0.068 | 25.008 | 24.903 | 0.420 |
| 3 | 1 | 3 | 40 | 14.8 | 91.6 | 25.023 | 25.002 | 0.084 | 25.003 | 24.763 | 0.960 |
| 4 | 1 | 4 | 40 | 12.3 | 90.8 | 25.006 | 24.987 | 0.076 | 25.006 | 24.895 | 0.444 |
| 5 | 1 | 5 | 40 | 15.9 | 91.7 | 24.995 | 24.977 | 0.072 | 24.994 | 24.890 | 0.416 |
| 6 | 1 | 6 | 40 | 11.0 | 91.6 | 25.039 | 25.018 | 0.084 | 24.995 | 24.881 | 0.456 |
| 7 | 1 | 7 | 40 | 17.1 | 91.4 | 25.009 | 24.992 | 0.068 | 25.002 | 24.888 | 0.456 |
| 8 | 1 | 8 | 40 | 14.8 | 90.9 | 25.000 | 24.979 | 0.084 | 25.048 | 24.932 | 0.463 |
| 9 | 1 | 9 | 40 | 16.4 | 92.0 | 24.999 | 24.977 | 0.088 | 25.043 | 24.937 | 0.423 |
| 10 | 1 | 10 | 40 | 14.5 | 91.4 | 25.036 | 25.015 | 0.084 | 24.993 | 24.849 | 0.576 |
| 11 | 1 | 11 | 40 | 15.0 | 91.7 | 25.038 | 25.018 | 0.080 | 25.010 | 24.820 | 0.760 |
| 12 | 1 | 12 | 40 | 15.2 | 92.6 | 24.999 | 24.982 | 0.068 | 25.033 | 24.935 | 0.391 |
| 13 | 1 | 13 | 40 | 16.3 | 92.1 | 25.015 | 24.999 | 0.064 | 25.044 | 24.931 | 0.451 |
| 14 | 1 | 1 | 50 | 10.6 | 93.8 | 25.016 | 24.998 | 0.072 | 25.009 | 24.903 | 0.424 |
| 15 | 1 | 1 | 60 | 9.5 | 95.2 | 25.017 | 25.001 | 0.064 | 24.992 | 24.875 | 0.468 |
| 16 | 3 | 1 | 40 | 14.9 | 92.0 | 25.015 | 24.997 | 0.072 | 25.003 | 24.889 | 0.456 |
| 17 | 4 | 1 | 40 | 14.6 | 91.4 | 25.013 | 24.994 | 0.076 | 25.012 | 24.905 | 0.428 |
| 18 | 5 | 1 | 40 | 14.2 | 91.3 | 25.029 | 25.011 | 0.072 | 25.001 | 24.897 | 0.416 |
| 19 | 1 | 14 | 40 | 20.5 | 92.2 | 25.016 | 24.990 | 0.104 | 25.008 | 24.895 | 0.452 |
| 20 | 1 | 15 | 40 | 20.8 | 91.3 | 25.025 | 24.984 | 0.164 | 25.017 | 24.917 | 0.400 |
| 21 | 1 | 16 | 40 | 21.0 | 91.8 | 25.027 | 25.009 | 0.072 | 25.032 | 24.928 | 0.415 |
| 22 | 1 | 17 | 40 | 8.2 | 91.0 | 24.996 | 24.982 | 0.056 | 25.040 | 24.939 | 0.403 |
| 23 | 6 | 1 | 40 | 14.5 | 92.5 | 25.050 | 24.963 | 0.347 | 25.037 | 24.938 | 0.395 |
| 24 | 1 | 18 | 40 | 14.5 | 92.1 | 25.017 | 25.006 | 0.044 | 25.002 | 24.893 | 0.436 |
| 25 | 1 | 19 | 40 | 14.9 | 91.7 | 24.999 | 24.982 | 0.068 | 25.037 | 24.967 | 0.280 |
| 26 | 7 | 1 | 40 | 14.3 | 91.5 | 25.041 | 25.023 | 0.072 | 25.021 | 24.921 | 0.400 |
| 27 | 1 | 20 | 40 | — | 90.3 | 25.008 | 24.997 | 0.044 | 25.036 | 24.937 | 0.395 |
| 28 | 1 | 21 | 40 | 13.8 | 91.2 | 25.006 | 24.989 | 0.068 | 25.010 | 24.904 | 0.424 |
| 29 | 1 | 22 | 40 | 14.9 | 91.3 | 24.998 | 24.972 | 0.104 | 25.007 | 24.904 | 0.410 |
| 30 | 1 | 23 | 40 | 15.1 | 91.0 | 25.018 | 24.971 | 0.118 | 25.038 | 24.922 | 0.464 |

### <Production Example of Developer>

### <Production Example of Two-Component Developer

To 90 parts by mass of the magnetic carrier 1, 10 parts by mass of the toner was added, and the mixture was shaken with a shaker (trade name: YS 8D type, manufactured by Yayoi Co., Ltd.), and 300 g of a two-component developer 1 was prepared. The conditions of shaking with a use of the shaker were set to 200 rpm and 5 minutes.

### <Production Examples of Two-Component Developers 2 to 30>

Two-component developers 2 to 30 were obtained by performing a same operation as in the production example of the two-component developer 1, except that the combination was changed to the combinations shown in Table 5.

### <Production Example of Replenishment Developer 1>

To 5 parts by mass of the magnetic carrier 1, 95 parts by mass of the toner was added, the mixture was mixed for 5 minutes by a V-type mixer, and a replenishment developer 1 was obtained.

### <Production Examples of Replenishment Developers 2 to 30>

Replenishment developers 2 to 30 were obtained by performing a same operation as in the production example of the replenishment developer 1, except that the combination was changed to the combinations shown in Table 5.

### Example 1

As an image forming apparatus, a modified machine of a full-color copying machine (trade name: image PRESS V1350) manufactured by CANON KABUSHIKI KAISHA was used. The image forming speed was set to 100 sheets/min for an A4 size and a full color. The apparatus was modified so that a development contrast could be adjusted to an arbitrary value, and that automatic correction by the main body did not work.

As evaluation paper, GFC-081 (81.0 g/m²) (Canon Marketing Japan Inc.) was used.

The image forming apparatus was modified so that an image could be output in a single color.

For information, in each measurement, the measurement was repeated a number of times at which the measurement error becomes sufficiently small, and the arithmetic average value thereof was adopted as the measured value.

### (1) Evaluation of Image Density

Into a developing device, 600 g of the two-component developer 1 was charged, a replenishment developer container was set into which the replenishment developer 1 was charged, an image was formed, and a durability test was performed. A durability test was performed under the following conditions.
Temperature 23° C./humidity 5% RH
Number of sheets of output image: 10000 sheets
Output image: FFH output chart with image ratio of 2%

Here, FFH is a value that indicates 256 gradations with a hexadecimal number, and in which OOH is first gradation (white background) of the 256 gradations, and FFH is 256th gradation (solid area) of the 256 gradations.

The square FFH patch of 1 cm square was output before the start of the test, the development contrast was adjusted so that the value of cyan of the image density of the patch portion became 1.55, which was measured by a spectral densitometer eXact Advance (manufactured by Videojet X-Rite K.K.), and the image forming apparatus was set so as to maintain this development contrast during the durability test from then on. After the test, a similar square FFH patch was output again, and a value of cyan of the image density was measured. It was determined that the numerical value was higher, the more the increase in charge during the durability test was more suppressed, and the image density could be maintained.

The evaluation of the present test was determined according to the following criteria, on the square FFH patch density which was output after the durability test.
A: 1.50 or higher
B: 1.40 or higher and lower than 1.50
C: 1.30 or higher and lower than 1.40
D: lower than 1.30

### (2) Evaluation of Suppression of Toner Contamination

Into a developing device, 600 g of the two-component developer 1 was charged, a replenishment developer container was set into which the replenishment developer 1 was charged, an image was formed, and a durability test was performed. The durability test was performed under the following conditions.
Temperature 27° C./humidity 80% RH
Number of sheets of output image: 300000 sheets
Output image: FFH output chart with image ratio of 40%

The square FFH patch of 1 cm square was output before the start of the test, the development contrast was adjusted so that the value of cyan of the image density of the patch portion became 1.45, which was measured by a spectral densitometer eXact Advance (manufactured by Videojet X-Rite K.K.); and after that, the same measurement was performed after every 500 sheets of image output in the durability test, and the development contrast was adjusted so that the value of cyan of the image density of the patch portion became 1.45 each time.

An evaluation of the present test was performed by visually checking the degree of toner contamination inside the image forming apparatus after the durability test, and comparing the degree according to the following criteria. It was determined that the degree of toner contamination was smaller, the effect of maintaining the charge even in use under a high-humidity environment was higher.
A: toner contamination is not observed.
B: toner contamination is very slightly observed or is observed only locally.
C: toner contamination is observed on the whole, but there is no influence on the output image, and there is no problem in practical use.
D: toner contamination is observed on the whole, and such problems in actual use are observed that the output image is affected.

### Examples 2 to 25 and Comparative Examples 1 to 5

The same evaluations as in Example 1 were performed except that the developers to be used were changed to combinations shown in Table 5.

Table 5 shows the evaluation results in each of the Examples and the Comparative Examples. In the case where the evaluation was C or higher in all the evaluation results, it was determined that the effect of the present disclosure was exhibited.

TABLE 5

| | | | | Magnetic | | (2) |
|---|---|---|---|---|---|---|
| | | Magnetic | Two- | carrier used | (1) | Evaluation of |
| | | carrier used in | component | in two- | Evaluation | suppression |
| | Replenishment | replenishment | developer | component | of image | of toner |
| | developer No. | developer No. | No. | developer No. | density | contamination |
| Example 1 | 1 | 1 | 1 | 1 | A \| 1.532 | A |
| Example 2 | 2 | 2 | 2 | 2 | A \| 1.531 | A |
| Example 3 | 3 | 3 | 3 | 3 | A \| 1.526 | C |
| Example 4 | 4 | 4 | 4 | 4 | B \| 1.492 | A |
| Example 5 | 5 | 5 | 5 | 5 | A \| 1.528 | B |
| Example 6 | 6 | 6 | 6 | 6 | B \| 1.476 | A |
| Example 7 | 7 | 7 | 7 | 7 | A \| 1.529 | C |
| Example 8 | 8 | 8 | 8 | 8 | A \| 1.523 | B |
| Example 9 | 9 | 9 | 9 | 9 | A \| 1.516 | B |
| Example 10 | 10 | 10 | 10 | 10 | A \| 1.520 | B |
| Example 11 | 11 | 11 | 11 | 11 | A \| 1.518 | C |
| Example 12 | 12 | 12 | 12 | 12 | B \| 1.473 | A |
| Example 13 | 13 | 13 | 13 | 13 | C \| 1.389 | A |
| Example 14 | 14 | 14 | 14 | 14 | B \| 1.456 | B |
| Example 15 | 15 | 15 | 15 | 15 | C \| 1.368 | B |
| Example 16 | 16 | 16 | 16 | 16 | A \| 1.516 | B |
| Example 17 | 17 | 17 | 17 | 17 | A \| 1.506 | B |
| Example 18 | 18 | 18 | 18 | 18 | A \| 1.501 | C |
| Example 19 | 19 | 19 | 19 | 19 | A \| 1.531 | B |
| Example 20 | 20 | 20 | 20 | 20 | A \| 1.533 | C |
| Example 21 | 21 | 21 | 21 | 21 | B \| 1.426 | A |
| Example 22 | 22 | 22 | 22 | 22 | C \| 1.327 | A |
| Example 23 | 28 | 28 | 28 | 28 | C \| 1.386 | A |
| Example 24 | 29 | 29 | 29 | 29 | A \| 1.511 | B |
| Example 25 | 30 | 30 | 30 | 30 | B \| 1.486 | C |
| Comparative | 23 | 23 | 23 | 23 | A \| 1.524 | D |
| Example 1 | | | | | | |
| Comparative | 24 | 24 | 24 | 24 | D \| 1.286 | A |
| Example 2 | | | | | | |
| Comparative | 25 | 25 | 25 | 25 | A \| 1.503 | D |
| Example 3 | | | | | | |
| Comparative | 26 | 26 | 26 | 26 | A \| 1.516 | D |
| Example 4 | | | | | | |
| Comparative | 27 | 27 | 27 | 27 | D \| 1.276 | B |
| Example 5 | | | | | | |

As in the above, in the present disclosure, a decrease in the image density caused by an excessive increase in the charged amount of the toner in a low-humidity environment can be suppressed, and contamination in the image forming apparatus due to toner scattering caused by a decrease in the charged amount of the toner under a high-humidity environment can be suppressed.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-110317, filed Jul. 9, 2024, which is hereby incorporated by reference herein in its entirety.

What is claimed is:

1. A magnetic carrier for electrostatic charge image development, comprising:
a magnetic core particle; and
a coating resin layer that covers a surface of the magnetic core particle, wherein
the magnetic core particle is a particle having a silicone resin on the surface;
the coating resin layer is a layer comprising a vinyl-based resin as a binder resin, and comprising a silica particle; and
when a mass of the magnetic carrier for electrostatic charge image development after having been held for 5 hours in a first environment of a temperature of 30° C. and a relative humidity of 80% is defined as M1, and a mass of the magnetic carrier for electrostatic charge image development which has been held in the first environment for 5 hours, after having been held in a second environment of a temperature of 23° C. and a relative humidity of 5% for 5 hours, is defined as M2, M1 and M2 satisfy Expression (1):
$$0.055 \leq ( M 1 - M 2 ) / M 1 \times 100 \leq 0.2 . \qquad Expression ( 1 )$$

2. The magnetic carrier for electrostatic charge image development according to claim 1, wherein a coverage with the silicone resin on the surface of the magnetic core particle is 60% or more.

3. The magnetic carrier for electrostatic charge image development according to claim 1, wherein when an abundance ratio of silicon atoms on the surface of the magnetic core particle is defined as Si_atm (atomic %), and a total abundance ratio of iron, manganese, magnesium, strontium, copper, zinc, nickel and cobalt atoms is defined as M_atm (atomic %), the Si_atm and the M_atm satisfy Expression (2):
$$M\_atm / Si\_atm < 0.4 . \qquad Expression ( 2 )$$

4. The magnetic carrier for electrostatic charge image development according to claim 1, wherein a proportion of an area of a portion in which the silica particles are exposed with respect to a surface area of the coating resin layer is 10% or larger, on the surface of the magnetic carrier for electrostatic charge image development.

5. The magnetic carrier for electrostatic charge image development according to claim 1, wherein when a mass of the silica particle after having been held in the first environment for 5 hours is defined as M3, and when a mass of the silica particle which has been held in the first environment for 5 hours, after having been held in the second environment for 5 hours, is defined as M4, M3 and M4 satisfy Expression (3):
$$3. \leq ( M3 - M4 ) / M 3 \times 100 \leq 10. . \qquad Expression ( 3 )$$

6. The magnetic carrier for electrostatic charge image development according to claim 1, wherein when a mass of the vinyl-based resin after having been held in the first environment for 5 hours is defined as M5, and when a mass of the vinyl-based resin which has been held in the first environment for 5 hours, after having been held in the second environment for 5 hours, is defined as M6, M5 and M6 satisfy Expression (4):
$$0 \leq ( M 5 - M 6 ) / M 5 \times 100 \leq 0.6 . \qquad Expression ( 4 )$$

7. The magnetic carrier for electrostatic charge image development according to claim 1, wherein the silica particle is a wet silica particle.

8. The magnetic carrier for electrostatic charge image development according to claim 1, wherein a volume-average particle diameter of the silica particle is 50 nm or larger and 250 nm or smaller.

9. The magnetic carrier for electrostatic charge image development according to claim 1, wherein a number of silanol groups present on a surface of the silica particle, per unit surface area of the silica particle is 1.0/nm² or larger and 2.0/nm² or smaller.

10. The magnetic carrier for electrostatic charge image development according to claim 1, wherein the vinyl-based resin comprises a unit derived from a (meth)acrylic acid ester monomer.

11. The magnetic carrier for electrostatic charge image development according to claim 1, wherein the vinyl-based resin is a copolymer comprising at least one type of monomer containing a (meth)acrylic acid ester having a cyclic hydrocarbon group in a molecular structure.

12. The magnetic carrier for electrostatic charge image development according to claim 1, wherein the magnetic core particle has a structure in which the silicone resin is filled in pores of a magnetic particle having the pores.
